(19) United States
(12) Patent Application Publication
(10) Pub. No.: US 2013/0041950 A1
(43) Pub. Date: Feb. 14, 2013

(54) Reference Object Information System

(71) Applicant: Jawe Chan, Pleasanton, CA (US)

(72) Inventor: Jawe Chan, Pleasanton, CA (US)

(21) Appl. No.: 13/475,475

(22) Filed: May 18, 2012

Related U.S. Application Data
(63) Continuation-in-part of application No. 12/987,974, filed on Jan. 10, 2011.
(60) Provisional application No. 61/487,288, filed on May 18, 2011.
(60) Provisional application No. 61/521,762, filed on Aug. 10, 2011.
(60) Provisional application No. 61/536,059, filed on Sep. 19, 2011.
(60) Provisional application No. 61/556,180, filed on Nov. 5, 2011.
(60) Provisional application No. 61/600,967, filed on Feb. 20, 2012.

(51) Int. Cl. G06F 15/16

(52) U.S. Cl. 709/204

(57) ABSTRACT

A method and apparatus for sharing identification of a computer embedded object between a plurality of users connecting to a computer network or participating in a social networking service is provided. The method and apparatus comprises receiving information relating to a computer embedded object of a first user of the plurality of users. The method and apparatus also includes sending the information of the computer embedded object to a second user for display.

### CROSS-REFERENCE TO RELATED APPLICATIONS; PRIORITY CLAIM

This Non-Provisional Patent Application is a Continuation in Part and claims benefit of U.S. patent application Ser. No. 12/987,974, filed Jan. 10, 2011; U.S. Provisional Patent Application No. 61/487,288, filed May 18, 2011; U.S. Provisional Patent Application No. 61/521,762, filed Aug. 10, 2011; U.S. Provisional Patent Application No. 61/536,059, filed Sep. 19, 2010; U.S. Provisional Patent Application No. 61/556,180, filed Nov. 15, 2011; U.S. Provisional Patent Application No. 61/600,967, filed Feb. 20, 2012 the entire contents of each is hereby incorporated by reference as if fully set forth herein, under 35 U.S.C. §119(e).

### FIELD OF THE INVENTION

The present invention relates to accessing information using searching criteria derived from identification code, specification, or configuration of a list of the user computer system.

### BACKGROUND

The Internet is a revolutionary technology for accessing information. A user may access information around the world with a simple click of a mouse button. In light of society's popular acceptance of the Internet, the amount of information accessible via the Internet has been growing exponentially. For example, a user may receive a large amount of merchandise-related information using a shopping search engine. In many cases, the user only needs the merchandise information that is filtered based on search criteria derived from the user's computer identification or the user's computer specification. The information may be further used for shopping purposes.

From time to time, a user may search for merchandise on the internet, such as, for example, a mobile computing device. In many cases, the reason why the user is searching is to replace his or her existing device. Mobile devices, mobile phones, and mobile phone accessories are most often promoted or sold by a wireless carrier associated with a wireless subscription plan and the actual sale of such a device is normally conducted in a local retail store.

Most websites provide static pictures of the mobile devices or cell phones. The websites do not display any relationship between one or more known devices owned by the user and the rest of the devices available on the website. For example, a user may login onto a cellular carrier's website and use the user's phone number to locate the user's current cellular phone model information. The cellular carrier has the user's information because the user is an existing customer. However, the website does not does not use any of the user's cellular phone model information for the user's shopping experience, such as a comparison between a candidate cellular phone feature and the cellular phone that the user currently owns. In this example, the user has a difficult time understanding or comprehending the value or feature set of a candidate cellular phone without the assistance of a live customer representative.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of a server that stores and retrieves object data, according to possible embodiments of the present invention;

FIG. 2 illustrates an example of end-user computers communicating with a server, according to a possible embodiment of the present invention;

FIG. 3 illustrates an example block diagram of an associated embedded computer system, according to a possible embodiment of the present invention;

FIG. 4 illustrates a user interface screen, according to a possible embodiment of the present invention;

FIG. 5 illustrates an example search results screen, according to a possible embodiment of the present invention;

FIG. 6 illustrates a user interface screen, according to a possible embodiment of the present invention;

FIG. 7 illustrates an example search results screen, according to a possible embodiment of the present invention;

FIG. 8 illustrates an example process flow, according to a possible embodiment of the present invention;

FIG. 9 illustrates an example process flow, according to a possible embodiment of the present invention;

FIG. 10 illustrates an example hardware platform on which a computer or a computing device as described herein may be implemented, according a possible embodiment of the present invention;

FIG. 11 illustrates an example comparison display screen, according a possible embodiment of the present invention;

FIG. 12 illustrates an example process flow of a server sending comparison specifications of merchandise of interest to a user computer, according to a possible embodiment of the present invention;

FIG. 13 illustrates an example process flow of a user computer displaying search result content from a server, according to a possible embodiment of the present invention;

FIG. 14 illustrates an example process flow of a user computer filtering search result content from a server, according to a possible embodiment of the present invention;

FIG. 15 illustrates an example process flow of a user computer displaying a list of search results content from a server, according to a possible embodiment of the present invention;

FIG. 16 illustrates an example process flow of a user computer displaying comparison search result content from a server, according to a possible embodiment of the present invention;

FIG. 17 illustrates an example process flow of a user computer displaying comparison search result content from a server, according to a possible embodiment of the present invention;

FIG. 18 illustrates an example process flow of a user computer displaying percentage improvement search result content from a server, according to a possible embodiment of the present invention;

FIG. 19 illustrates an example process flow of a user computer displaying correlated search result content, according to a possible embodiment of the present invention.

FIG. 20 illustrates a user computer sending the identification code of the associated computer to the server or to the user computer through a possible computer network connection, according to a possible embodiment of the present invention;

FIG. 21 illustrates a user interface display of a list of the computers and associated information that the user is interested in, according to a possible embodiment of the present invention;

FIG. 22 illustrates a user interface display of blog permissions for a list of users, according to a possible embodiment of the present invention;

FIG. 23 illustrates a user interface display of a list of search results corresponding to a potential upgrade request, according to a possible embodiment of the present invention;

FIG. 24 illustrates a user interface display of search results, from a search criteria derived from an identification code of an associated computer, for a possible upgrade or replacement of the associated computer, according to a possible embodiment of the present invention;

FIG. 25 illustrates a user interface on a user computer, such as smart phone, according to a possible embodiment of the present invention;

FIG. 26 illustrates a database that contains information corresponding to an associated computer, according to a possible embodiment of the present invention;

FIG. 27 illustrates a database that combines a list of computers connected on the computer network and an existing specification database, according to a possible embodiment of the present invention;

FIG. 28 illustrates a process flow of a search of a database to retrieve the specification of an associated computer by using the host name of the user computer, according to a possible embodiment of the present invention;

FIG. 29 illustrates an example process flow of a search of a database to retrieve the specification of an associated computer by using the identification code of the user computer, according to a possible embodiment of the present invention. In this example, the process flow use hostname, from a computer network, of the associated computer embedded object to search a data base to find the specification of the associated computer embedded object through the identification code of the associated computer embedded object;

FIG. 30 illustrates a process flow for correlating the identification code of a computer to the corresponding host name of the computer, according to a possible embodiment of the present invention;

FIG. 31 illustrates a process flow for a search for a replacement of network computer or accessories of a network computer by accessing the host name of the network computer from a user computer, according to a possible embodiment of the present invention; and

Referring to FIG. 32 illustrates a process flow to link the hostname of a computer to the identification code or specification of the corresponding computer on a computer network, according to a possible embodiment of the present invention.

### DESCRIPTION OF EXAMPLE POSSIBLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Example embodiments are described herein according to the following outline:
1. GENERAL OVERVIEW
2. EXAMPLE SYSTEM ARCHITECTURE
3. EXAMPLE PROCESS FLOW
4. AUTOMATIC PAGE FORMATTING FOR DIVERSE DEVICES
5. REVENUE GENERATION
6. SOCIAL NETWORKING SERVICES
7. EXAMPLE EMBODIMENTS
8. HARDWARE OVERVIEW
9. EXAMPLE EMBODIMENTS
10. EQUIVALENTS, EXTENSIONS, ALTERNATIVES AND MISCELLANEOUS

### 1. General Overview

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format, and should be understood as merely a conceptual prelude to a more detailed description of example possible embodiments that follows below.

In an example embodiment, a system and method for accessing information relating to a computer embedded object is described. Information related to a computer embedded object may be found through a specification searching criteria derived from a specification or/and identification code of a computer embedded object that the user's computer is associated with. The specification or identification code of the associated computer embedded object may be stored in RAM, ROM, Flash Memory, etc., of the associated computer embedded object and may be delivered to the user computer through a computer network connection. In an example embodiment, the associated computer embedded object may be communicatively connected to the user's computer by any one of the following network connection methods: Ethernet, ASDL, wireless, USB, fiber optic, power line computer network, modem, etc. The associated computer embedded object may have been previously in communication with the user's computer or a server (the identification codes of the associated computer embedded object may be saved in a memory or storage device of the user computer or a server), or is currently communicatively connected to the user computer.

In an example embodiment, the network communication between computers may comply with the Open Systems Interconnection model (OSI model). The OSI model is a way of sub-dividing a communications system into smaller parts called layers. Similar communication functions are grouped into logical layers. The identification code, specification or configuration of the associated computer embedded object may be transferred through one, if not all, of the following layers—Physical Layer, Data Link Layer, Network Layer, Transport Layer, Session Layer, Presentation Layer, and Application Layer—as described in the OSI Model. The data, including the identification code or specification or configuration of the associated computer embedded object, is encapsulated and sent from the associated computer embedded object to the user or server computer. The user or server receives and de-encapsulates the data. The search criteria derived from the data, includes the identification code, specification, or configuration of the associated computer embedded object.

In an example embodiment, the specification, identification code or configuration of the computer embedded object may be accessed by the user computer using the hostname of the computer embedded object. A hostname may be a label that is assigned to a computer embedded object connected to a computer network that may be used to identify the computer embedded object in various forms of electronic communication. A user id and password may be needed, along with the hostname of the computer embedded object, in order to gain the access to the specification, identification code, or configuration of the computer embedded object. In an example embodiment, the specification, identification code, or configuration of the computer embedded object may be stored in a flash memory, disk drive, etc. In an example embodiment, the hostname of the computer embedded object is the hostname of the associated computer embedded object. The identification code of the computer embedded object may be used, by the server or user computer, to search a database in order to identify more specification information for the computer embedded object.

The identification code or specification of a computer embedded object that associated with the user computer may be delivered to the server as part of the search criteria using at least one of the following approaches:

1) The identification code or specification of the associated computer embedded object maybe delivered to the server directly or through a user computer. In this case, the user computer is already connected to a computer network.

2) The identification code or specification of the associated computer embedded object maybe delivered to user computer or server. The identification code or specifications may be saved in a memory or storage device in the user computer or server. The search criteria may be derived from the identification code or specification of the associated computer embedded object that is saved in the memory of the user computer or server. In an example embodiment, the user computer or server, through a computer network connection, may save a list of the identification codes or specifications of multiple associated computer embedded objects embedded objects in a storage device. The search criteria may be derived from this list of the multiple identification codes or specifications. In an example embodiment, the list of the identification codes or specifications of the associated computer embedded object may deliver to a memory or storage device via computer network connection from each of the corresponding associated computer embedded object.

3) Multiple identification codes, or specifications of the associated computer embedded objects embedded objects may be delivered to the server directly or through user computer, as part of the user search criteria;

The information deliver to the user may be consumer information related to a mobile device, a computer embedded object, a vehicle, an accessory of a mobile device, a mobile subscription plan, promotion or coupon information of a service or merchandise, or anything related to the associated computer embedded object. The identification code may be used to identify the associated computer embedded object and its specification, e.g., a hardware description, such as: microprocessor, memory size/type, display screen type/resolution, whether the display screen is monochrome or color, color bit depth, keyboard specification, communication connection number/type, etc.; or software description, such as: operating system, application programs native/added, etc. The identification code is selected from at least one the group consisting of: string of codes, IP (Internet Protocol) address, MAC (Media Access Control) address, host name, IMSI (International Mobile Subscriber Identity), TMSI (Temporary Mobile Subscriber Identity), IMEI (International Mobile Equipment Identity), TAC (Type Allocation Code), MEDI (Mobile Equipment Identifier), string of ASCII characters, serial number, FCC ID, model number, communication data rate, etc. The accessed information may be merchandise information specified by the user or advertisement information displayed to the user by a service provider.

In an example embodiment, the specification of the associated computer embedded object may be automatically obtained. Advertisement(s) or search results (from a search criteria) may be customized and sent to the user's computer using the specification of the associated computer embedded object. The associated computer embedded object may be a mobile device, cell phone device, ebook device, gaming computing device, mobile accessory, any electronic device with a microcontroller/microprocessor, etc. The specification of the associated computer embedded object may be replaced by the identification code of the associated computer embedded object. In this case, the specification of the associated computer embedded object may be derived from the identification code of the associated computer embedded object by a server. In an example embodiment, the specification of an associated computer embedded object may includes the identification code of that computer.

In an example embodiment, the configuration of the associated computer embedded object may be automatically obtained. The associated computer embedded object may be a mobile device, cell phone device, ebook device, gaming computing device, mobile accessory, any electronic device with a microcontroller/microprocessor, etc. The configuration

In an example embodiment, the configuration of an associated computer embedded object may include a hardware option of an associated computer embedded object. In an example, a mobile phone might include a 16 G Byte of the Secure Digital (SD) card rather than 32 G Byte of the SD card.

In an example embodiment, an advertisement may be displayed automatically to a user computer as a function of the specification of the associated computer embedded object or identification code of the associated computer embedded object. The advertisement may be in a form of an electronic banner, text advertisement, email, text message, etc. The automation may be implemented by program instructions that read the specification of the user computer, which may or may not include the identification code of the associated computer embedded object.

In an example embodiment, the identification code or specification of a first computer embedded object may be accessed by a second computer, on a computer network, using program instructions or machine code instructions. The search criteria used to search a database may be derived from the identification code of the first computer, where the identification code may be automatically accessed by the second computer through a computer network. The first computer may have a program installed, e.g., a mobile software application, etc. The second computer may be also have a program installed, e.g., a mobile software application, etc. The identification code, configuration or specification of the first computer may be transferred to the second computer using, but not limited to, one or more of the following methods:

i) The second computer may be granted the access to the identification code or specification of the first computer according to a predefined list. The predefined list may contain a list of computer host names. If the second computer's host name matches one of the host names in the list, the first computer may deliver the identification code, specification, or configuration of the first computer to the second computer.

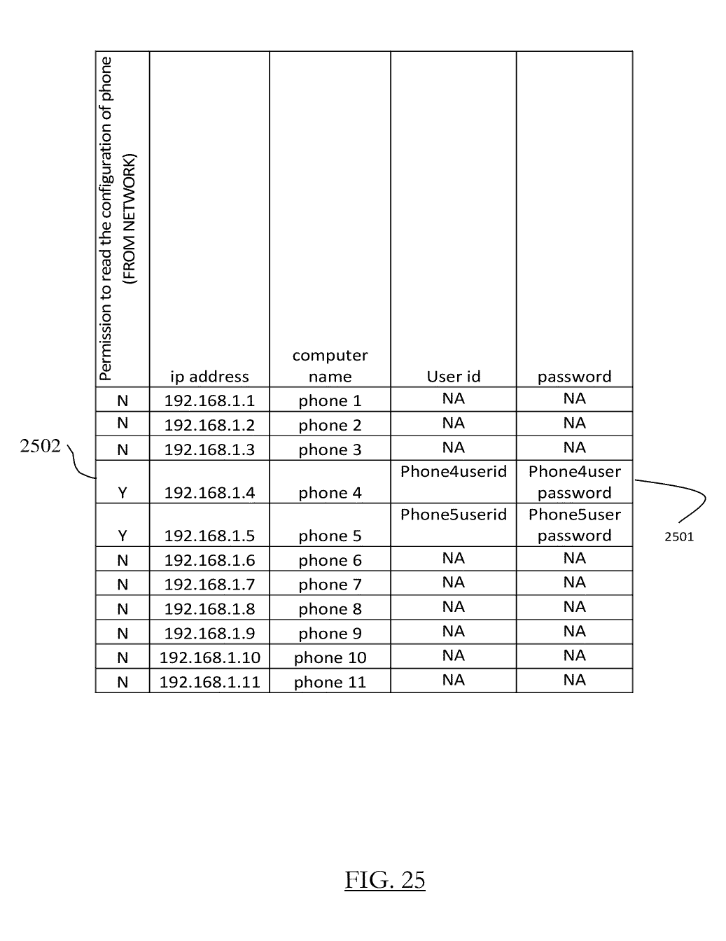

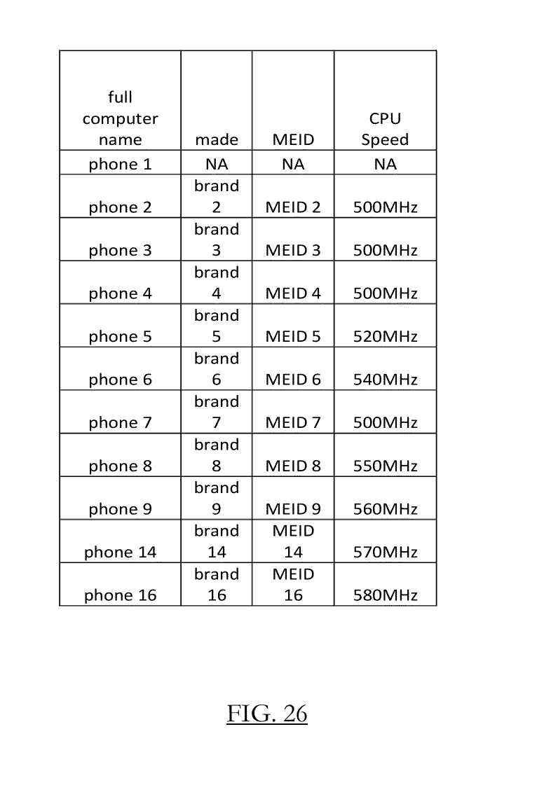

ii) The second computer may receive the identification code, specification or configuration of the first computer by querying a database that contains the host name of the first computer. The second computer queries the database by using the first computer's hostname, where the first computer's hostname may be received across a computer network that is connected to the second computer. See FIGS. 25 and 26.

iii) The first computer sends the identification code of the first computer to a database or storage device, for the second computer to access. The database or storage device may be physically or logically associated with a third computer, however to the identification code may be accessed by the second computer.

iv) The identification code of the first computer is stored in a database or storage device associated with the first computer and may be shared across the network computer. The identification code of the first computer may be stored to a shared drive on the computer network based on the first computer's request. For example, the identification code may be retrieved from a flash memory on the first computer by program code residing on the first computer and transferred to the share drive.

In an example embodiment, the search results using a search criteria may be customized and sent automatically to the user's computer as a function of the specification of the user's computer or identification code of the user's computer. The specification or identification code of the user's computer may be part of the user's profile or user's computer profile, which may be part of the search criteria setup by the user.

In an example embodiment, an identification code of a computer embedded object may be defined as an ID used to access the specification of a computer embedded object through a database.

In an example embodiment, a mobile device manufacturer may use an identification code (e.g., IMEI, etc.) to identify the model of the cellular phone. IMEI is made up of a TAC (Type Allocation Code) and a serial number called the SNR. The TAC identifies the phone manufacturer and model. There may also be several different TACs for the same model phone. Prior to 2004, the TAC consisted of the first six digits of the IMEI. Since then, the TAC has been allocated the first eight digits of the IMEI. The TAC is followed by a six digit SNR and a one bit checksum. This makes the IMEI a 15-digit number in recent phones and a 13-digit number in older (pre-2004) phones. A lookup table, a string of codes vs. mobile device model, or a mobile device specification, is available per mobile device manufacturer. With this lookup table, the mobile application software may send the string of codes to a server to retrieve the mobile device's specification. A featured mobile device (selected using promotional information) with similar or better specifications may be presented to the user using the mobile device specification.

In an example embodiment, a mobile device manufacturer may use a unique string of codes, such as a MAC address, to identify a mobile device. The string of codes should not be limited to IMEI or MAC addresses.

In an example embodiment, mobile device manufacturer may issue a coupon or discount or rebate whenever user is a repeat customer. In an example embodiment, a repeat customer may send in the old IMEI, old phone number, and old carrier information to the mobile device manufacturer before switching to a new wireless plan or new phone in exchange for a coupon, discount, or a rebate. In an example embodiment, a mobile device manufacturer may issue a discount based on the model of the phone to be replaced. The discount rate may vary. For example, the replacement of a high end phone receives a higher discount than a low end phone.

In an example embodiment, the searching criteria system uses a search criteria derived from an identification code or specification of an associated computer embedded object system. Merchandise information may be linked to an on-line shopping system or a commercial product promotion system.

In an example embodiment, the system provides information to upgrade an associated computer embedded object according to the current associated computer embedded object specification.

In an example embodiment, the system promotes a replacement computer according to the user's current associated computer embedded object specification.

In an example embodiment, a reward system may be implemented. After a user's information is found and the user has purchased the merchandise, the service provider that maintains the database or server may be paid a percentage of the purchasing price or paid a fixed amount. The seller, who may be the information provider, receives the remainder of the purchase proceeds from, for example, a pay service such as PayPal, a credit card company, etc.

In an example embodiment, a pay-per-click method or system may also be further added. Commercial enterprises may profit through this infrastructure, in many cases by providing services that attach a small, incremental monetary value to a particular transaction.

In an example embodiment, a pay-per-click search engine is provided. A user navigates to a search engine website and inputs the name of merchandise or services that he would like the pay-per-click company to find. Various providers of merchandise and services register their websites with the company. These are provided to the user in a list which is prioritized by the level of compensation which the merchant will compensate the pay-per-click company if the user is routed to their site. For example, using such a system, if a user types in “mobile phones,” the pay-per-click system may return one or more potential links, with the most prominent link being associated with the supplier of mobile phones that will compensate for the operator of the system for a some incremental amount more, e.g., a penny or a few cents, than the links presented below that link.

In an example embodiment, a comparison specification may be returned to the user's computer. If the user's associated computer embedded object is a cellular phone, the specification of the user's phone and candidate replacement phones may be compared in a side-by-side table format, or some of the specifications of the phone may be overlaid visually, pictorially, or graphically in a display format. Moreover, the comparison specification of the replacement unit (if the user searches for a replacement of the phone connected to user computer through a computer network) and the current associated cellular phone may be delivered to the user in any of the following formats: audio format, video display format, picture display format, text display format, etc. The comparison specifications may be defined but are not limited to any of the following: percentage of speed difference of the microprocessors, overlay of the form factor outline of the replacement and current computer, a comparison of operation system specifications, percentage increase of the replacement unit's memory size specification over the current unit, percentage increase of the replacement unit's memory speed specification over the current unit, percentage increase or decrease of dimension specification between the two units, percentage increase or decrease of weight specification between the two units, percentage difference of the color specification between the two units, benefit increase or decrease of the wireless subscription plan specification, percentage increase or decrease of the computer network connection speed specification between the two units, benefit of the different type of the computer network connection type specification between the two units, percentage of benefit of the display technology specification between the two units, percentage of increase or decrease of the display size specification between the two units, percentage of increase or decrease of the display resolution specification between the two units, percentage benefit of the software revision specification between the two units, increased area of the connection coverage availability specification, percentage benefit of the connection technology specification between the two units, percentage increase or decrease of the length of the battery consumption specification between the two units, percentage of the benefit of the camera resolution quality specification between the two units, etc. Again, the comparison specification search results, which are returned from server, may be derived from the specification of the following but are not limited to: the ID or specification of a computer connected to user computer through a computer network, the ID or specification of an associated computer embedded object that is stored in a user profile, the ID or specification of a user's purchasing history or input by a input device, such as but not limited to: a camera or a USB pen, that communicates with the user's computer. The comparison specification may be delivered to a user computer in an advertisement format. In this case, the server may initiate the advertisement. The comparison specification advertisement, derived from an ID or specification mentioned, may be delivered to the user.

In an example embodiment, a user logs into a shopping system to search a list of the accessories related to the first user's list of the identification codes of the computer embedded objects. The first user may upload the list and use this list to shop with. The first user may blog with a second user about an object description returned from the search result. For example, the first user may search for a device and would like to make comments on that device. The first user sends the shopping item description along with the comments to second user using a blog or message interface. The first user may save the device link with comments and send them to second user. The second user may open the comments and device link up to read. The users may share the reference computer embedded object list. The computer embedded object list may be shared among other users.

User may share information between computer embedded objects without a server—much like sharing phone numbers between household members. Reading the phone history without login into wireless carrier. A phone book, contact list, with phone model may be stored in a smart phone device. User may shop the phone or computer embedded object, from the phone book of the first user computer, for the second or third user.

### 2. Example System Architecture

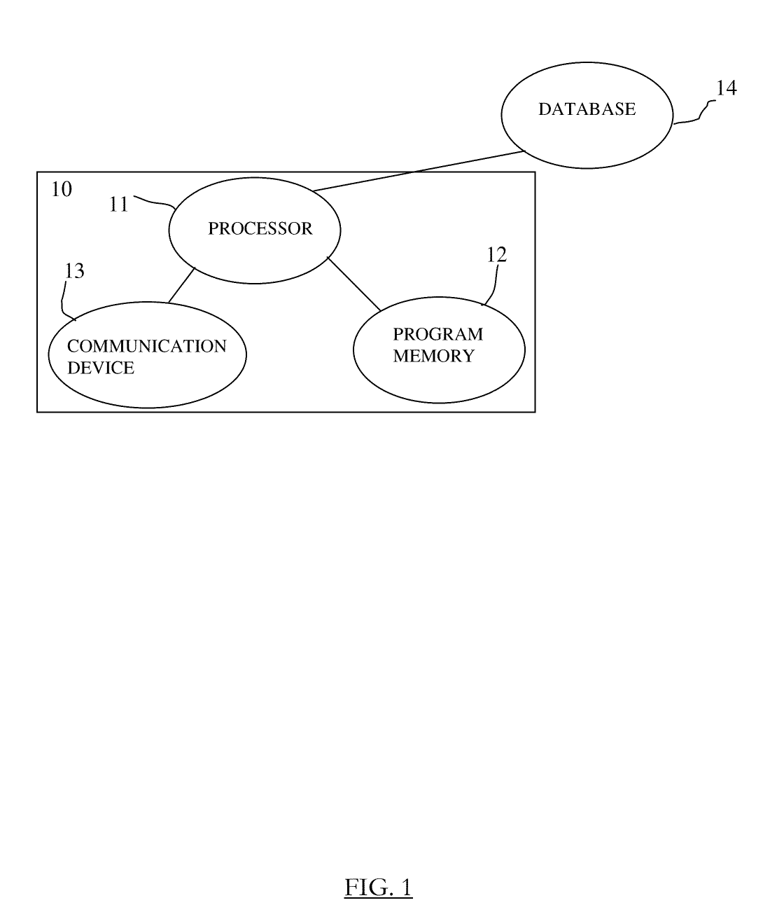

FIG. 1 illustrates a block diagram of a server 10 that stores and retrieves object data. Server 10 may include a processor 11, program memory 12, a communication device 13, and a database for objects 14. The communication device may be a modem or a high-speed router. In an example embodiment, server 10 is an information server and processor 11 is in data communication with various end-user computer systems via the Internet. However, in other possible embodiments, the server 10 could be implemented with a processor 11 having multiple modems to receive calls directly from end-user computer systems and establishing data communication via the modems and public phone lines, e.g., POTS. The database 14 may include the promotion information for objects that includes, but is not limited to: e-coupons, coupons or product sales events, price of an object, an identification of an object, etc.

An example of a server 10 is a system operating in accordance with the Sun MicroSystems Solaris operating system, Linux, Microsoft Windows Server, etc. Processor 11 may be any general-purpose processor having a CPU, RAM, ROM, and I/O circuitry.

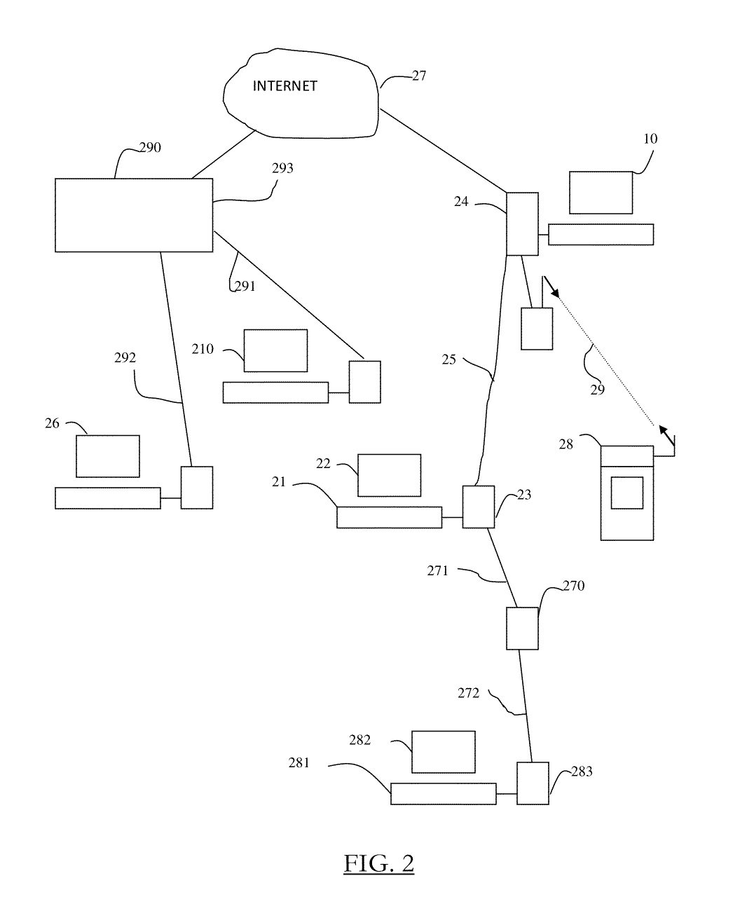

Referring to FIG. 2, end-user computers 21, 26, 28, communicate with server 10 in a variety of ways. In an example embodiment, end-user computer 26 is associated with a computer 210 through a computer network router 290. Box 290 may be a computer network router integrated with a DSL modem, cable modem, etc. Connection 292 may be a computer network connection from end-user computer 26 to a computer network router 290 via Ethernet, DSL modem, cable modem, etc. Connection 291 may be a computer network connection from an end-user associated computer embedded object 210 to computer network router 290. End-user computer 26 may be able to access identification code, specification or configuration of the associated computer embedded object 210 through computer network connection 291,292 and computer network router 290. In a further possible embodiment end-user computer 26 is also connected to server 10 through Internet 27. The search criteria of the end-user at computer 26 may be derived from the identification code and specification of the associated computer embedded object 210. In an example embodiment, end-user computer system 21 connects to server 10 via modem 23 and modem 24 through phone line 25. In an example embodiment, end-user computer 21 may be communicatively connected to a display device 22. In another possible embodiment, display device 22 may be incorporated within end-user computer 21. The end-user computer 21 may be associated with a computer 281 through a computer network connection 271, 272 and computer network router 270. End-user computer 21 may be able to access identification code or specification of the associated computer embedded object 281 through computer network connection 271, 272 and computer network router 270. In a further possible embodiment the search criteria of the end-user at computer 21 may be derived from the identification code and specification of the associated computer embedded object 281. In a further possible embodiment, End-user computer system 28 connects to server 10 through radio frequency link 29. The end-user computer 28 is associated with a computer 210 through internet 27. End-user computer 28 may be able to access identification code or specification of the associated computer embedded object 210 through computer network connection 29, 291, 293, computer network router 290, and internet 27. The search criteria of the end-user at computer 28 may be derived from the identification code and specification of the associated computer embedded object 210.

In a possible embodiment, server 10 access object information such as promotion information (e-coupon, coupon, product sales event, etc.) or business directory information in database 14 to provide a user with object promotion information. Database 14 may be a centralized database system that stores the data about object promotion information. However, in other possible embodiments, database 14 may be implemented as a distributed database system that stores the information in several computer systems and may be located in different geographical areas. Each of the distributed databases may store data about object information in a local area, such as a particular state, city, or country. In an example embodiment, consumer information may include information for user, such as any of or any combination of promotion information, advertisement information, business directory information, sales information, coupons.

In an example embodiment, database 14 may be implemented as a relational database, XML database, etc., using MySQL, PostgreSQL, Microsoft Access, SQL Server, FileMaker, Oracle, RDBMS, dBASE, Clipper, FoxPro, etc. Queries formed by server 10 are in a format corresponding to the database method being used by database 14. In other possible embodiments, database 14 may be implemented as a lookup table or a flat file. Computer IDs (identification code of the associated computer embedded object of the user's computer) and/or associated computer embedded object specifications may be searched for in database 14 in order to retrieve the object information that an end-user is looking for. Information for each computer is organized as a record in database 14 that describes the computer. Each record has at least the following searchable fields for each computer: computer ID (identification code of an associated computer) and associated computer embedded object specification.

In an example embodiment, database 14 may also include promotions database. The promotions database may contain coupons, e-coupon information, or sales event information. For example, for a three-day car charger sales event, the on sale car charger's specification may be derived from a searchable promotions database 14 and identification code of the user's associated computer embedded object, an electrical vehicle. The on sale car charger's specification may be sent to the user's computer and displayed on the display screen attached to the user's computer. The three-day sales price along with the start and stop limited sale date may also be displayed to the user. If there is a coupon for the car charger, the car charger coupon expiration date and discount may also be displayed to the user.

In an example embodiment, database 14 could also be arranged in an object-oriented manner for attribute searching.

In an example embodiment, database 14 may be configured to retrieve the relationship between the information of the associated computer embedded object or the associated mobile device collected and the target information to be accessed by the user. The targeted information to be accessed may be selected from one of the following group, repair service of the user computer, other information mention in this invention.

In an example embodiment, specifications of items that are available for commercial transaction may be displayed to the user. Server 10 analyzes data associated with items that are available for commercial transaction in order to identify one or more specification attributes of the items and associates the identified specification attributes with the items in order to facilitate searchable parameters. Database 14 may be arranged in a manner that allows a search to be made between a computer that may be associated with the user's computer specification and the associated specification attributes for the items. An identified item may be displayed based on a specification attribute of the item.

In an example embodiment, server 10 may receive a criterion specifying a specification attribute and identify items that share a specification attribute with the specification attribute specified by the criterion. The items may be identified to a user, and if desired, the user may obtain an identified item in a commercial transaction. In an example embodiment, a screen interface display may be supplied by the server 10 to the user's computer that is configured to receive a criterion specifying a specification attribute. Server 10 searches a catalog of items available for commercial transaction and identifies one or more items in the catalog based on the specification attribute specified by the criterion.

To facilitate the searching of items, database 14 may include one or more data structures for the items. The data structures may be prepared by analyzing items to identify specification attributes of the items, associating the identified specification attributes of the user computer with their respective items, and generating or updating one or more data structures for the items in which the specification attributes of the items are placed in a searchable field of the data structures. The data structures are searchable using a specification attribute, e.g., to identify specification related items.

In an example embodiment, computer ID includes a string of codes. Computer ID could also, or alternatively, include any of: an Internet Protocol (IP) address, a Media Access Control (MAC) address, a host name, an International Mobile Subscriber Identity (IMSI), a Temporary Mobile Subscriber Identity (TMSI), an International Mobile Equipment Identity (IMEI), or a Mobile Equipment Identifier (MEID), a TAC (Type Allocation Code), a string of ASCII characters, a serial number, an FCC ID, and a model number.

In an example embodiment, object specification includes, but is not limited to, one or more of the following: Operating System, Processor Speed, Memory Size, Memory Type, Dimension, Weight, Color, Style of the Object, Type of the Object, Subscription Plan, Computer network connection Speed, Computer network Connection Type, Display Technology, Display Size, Display resolution, Software Revision, Coverage Availability, Type of Battery, Camera Resolution Quality, Ability to be customized, Type of Keyboard, or GPS availability.

The following is an example of an object specification, where the object is a mobile device:

a. Type of Phone: flip phone, back flip

b. Operating System: Any Operating System for Mobile Phone 2.1

c. Processor: XYZ Brand 1 GHz mobile processor

d. Internal Memory: ROM 1 GB; RAM 576 MB

e. Compatibility: WiFi: 802.11 b/g*GPS/AGPS

f. Email: One Exchange, up to 7 POP/IMAP

g. Dimensions: 123×68×10 mm

h. Weight: 157 g (with battery)

i. Display: 4.3-inch HD touch-sensitive screen with 480×800 WVGA resolution

j. Technology: GSM: 850/900/1800/1900 MHz WCDMA/HSPA: 1700 MHz (AWS)/2100 MHz.

In this example, the type of phone may include, but is not limited to, any of: flip phone, back flip, candy bar, smart phone, sliding keyboard, soft keyboard, etc. The Operating System may include, but is not limited to, any of: Any Operating System for Mobile Phone 2.1, IOS 4, Windows CE, Windows Phone, Android, etc.

In an example embodiment, server 10 may send a portion of the database information in database 14 to an end-user computer 21, 26, 28. The end-user computer may have a local database manager that has the ability to search the portion of the database that it receives from the server 10. For example, server 10 may select the portion of the database information in database 14 using information such as the ID of the computer 281, 210 associated to the user's computer 21, 26, 28. The server 10 selects a portion of the information in database 14 that applies to the associated computer embedded object ID, e.g., the associated computer embedded object specification, any searchable items for commercial transactions, and advertisements, any other searchable information, etc. The server 10 sends the selected portion of the database to the user's computer. The user's computer may then perform information displays and searches locally in response to the user's commands and queries.

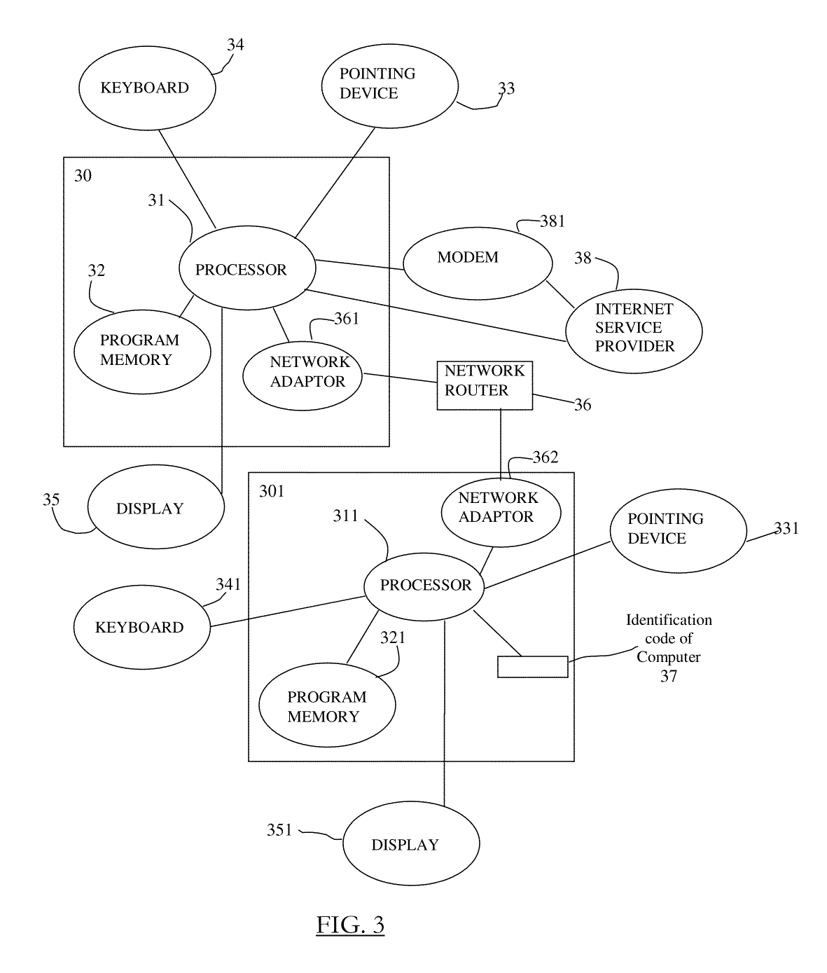

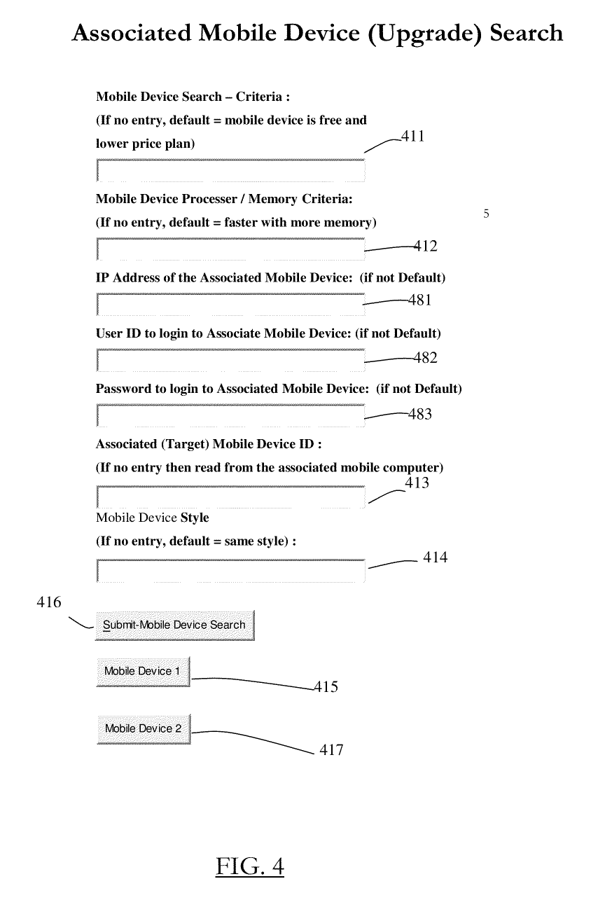

Referring to FIG. 3, a block diagram of an example associated computer embedded object system 301 that is associated with end-user computer system 30 is shown. Computer system 30 comprises a processor 31, program memory 32, a mouse 33 and keyboard 34 for user input, a display 35, a computer network adaptor 361, a modem 381 and a computer network router 36. Associated computer embedded object system 301 comprises a processor 311, program memory 321, a mouse 331 and keyboard 341, a display 351, a computer network adaptor 362, and identification code of the associated computer embedded object system 37. A connection from computer system 30 to an Internet Service Provider (ISP) 38 is also shown. The connection may be via broadband, wired, wireless, satellite, POTS, DSL, ADSL, etc. A connection through computer network router 36 from computer system 30 to the associated computer embedded object system 301 is also shown. In the environment of FIG. 2, system 30 is an end-user computer system, and processor 31 is in data communication with an Internet Service Provider 38. The Internet Service Provider 38 transmits the data to the server 10 via the Internet. In other possible embodiments, the system could be implemented with a processor 31 having a modem 381 calling directly to the server 10 and establishing the data communication link via the modem 381. Alternatively, the system could be implemented such that the end-user computer system 30 and server 10 are connected via a local computer network.

In an example embodiment, the computer network includes a data communication based on an Internet Protocol (IP). In another possible embodiment, the computer network includes a wired Local Area Network (LAN) such as an Ethernet LAN. In one embodiment, the computer network includes a Wireless Local Area Network (WLAN). In yet another possible embodiment, the computer network includes a Wide Area Network (WAN). In another possible embodiment, the computer network includes a public computer communication network, such as a WiFi hotspot, or a cellular data communication such as General Packet Radio Service (GPRS). In an example embodiment, the network includes a private computer communication network such as a home computer network, a corporate computer network, a regional corporate computer network or a corporate Virtual Private Network (VPN). In another possible embodiment, the computer network includes a service provider computer network.

The ID code of associated computer embedded object 37 may resident in the hardware of associated computer embedded object 301. In an example embodiment, the ID code may store in a flash memory or one time programmable memory of the associated computer embedded object. End-user computer system 30 may send the associated computer embedded object ID 37 to server 10. Alternatively, the end-user of end-user computer system 30 may input the ID code from another input device, for example from a keyboard 34, if the user knows the computer ID of the associated computer embedded object 301 or would like to search for object information using another computer ID.

An example of a suitable end-user computer system 30 or associated computer embedded object sysetm 301 is one operating in accordance with the Microsoft operating system, Apple Mac OS, Linux, etc. Processor 31 or 311 may be any general-purpose processor having a CPU, RAM, ROM, and I/O circuitry. Other input devices instead of, or in addition to, mouse 33 and keyboard 34 could be used, such as trackballs, touch pads, graphic tablet, or joysticks. The processor 31 is programmed to execute a process to help the user and accept and process the user's input.

### 3. Example Process Flow

FIG. 4 illustrates an example graphical user interface. The graphical user interface may be formatted for display on display 35. There are several input boxes and buttons on the graphical user interface configured to accept input from the user.

Data entry area 413 accepts input for an associated computer embedded object ID. The ID is an identification code to identify a computer's specification, based on that, the user may retrieve the information or the server may send the information (e.g., promotional information) to the end-user computer. The identification code of the associated computer embedded object may be Mobile Equipment Identifier (MEID). If the user doesn't know the MEID of the associated computer, the user could let application software resident on the user's computer retrieve the information, may be with an IP address, user id, and password, through a computer network connection that connected to the associated computer embedded object (alternatively, this may be a default setting). The user could choose MEID as the default setting by leaving data entry area 413 empty. The current associated computer's MEID is stored in program memory 321. It could be a string of hexadecimal numbers or string of codes as discussed above. By default, the MEID is chosen unless the user inputs other ID numbers in the data entry area 413.

Data entry area 411 accepts user input for a mobile device and search criteria. The default setting of this data entry area may be “free of charge on mobile device with a 2 year contract and wireless price plan is lower in cost than current plan”. Data entry area 412 accepts input for the target mobile device specification. The default setting of data entry area 412 may be “faster processor with more memory compared to the current associated mobile device”. Processor 31 receives the user data input from the search input entry area 412.

Data entry area 414 accepts input for the mobile device style. In an example embodiment, mobile device style signifies the keyboard style, either a soft keypad style or hard keypad style. In an example embodiment, processor 31 is able to differentiate the different mobile device styles that a user may enter, for example, the programming style, flip phone style or touch screen style, the color of the phone, the dimensions of the mobile device, etc. An API or software routine run by processor 31 may classify the user's input and decide what the user means by his data input.

Button 415 is the “submit button” for the user to click (or touch). The user may click or touch the button to submit the search criteria. Selectable buttons 416, 417 are the memory recall buttons to recall the phone information from a previous input or a previous search. The user may recall the phone information by clicking either the memory recall button 416 or 417.

Processor 31 organizes the received input, associated computer embedded object id, mobile device and search criteria, and mobile device processor and memory criteria, mobile device style criteria, as a message packet or database query. In an example embodiment, processor 31 sends the information to the server via Internet Service Provider 38 using, for example, a modem 381, phone line, cable modem, DSL modem, etc. The Internet Service Provider 38 further transmits the information to server 10. After receiving the information at server 10, processor 11 forms the search query and queries database 14.

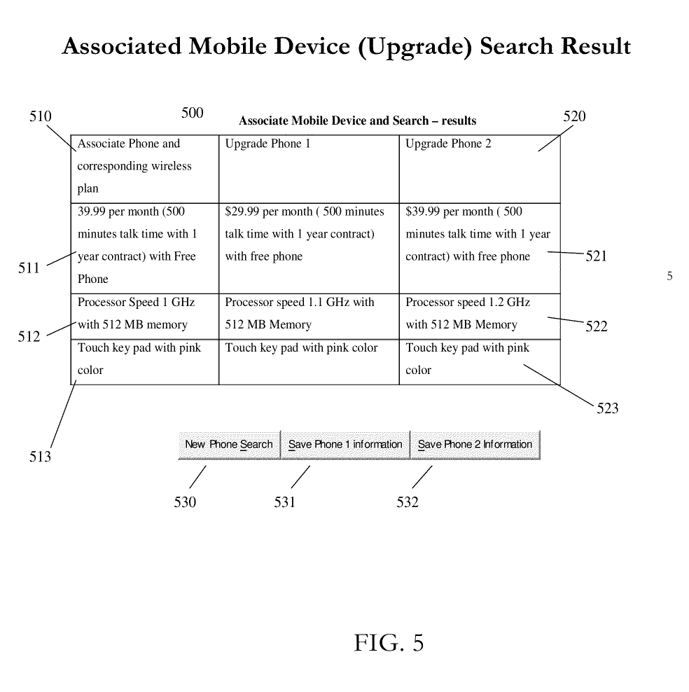

Referring to FIG. 5, processor 31 receives the search results and displays the results 500 to the user. Search results table 500 includes a display field 510 for the current associated phone identification and current associated phone wireless plan, a display field 511 for the current associated phone's price structure with the wireless subscription plan, a display field 512 for the current associated phone's processor specification and memory specification, and a display field 513 for the current associated phone's style.

The search results table 500 also includes information that displays the search results. Fields 520, 521, 522, 523 display results that match the search criteria. Field 520 displays the identifier of a phone. Field 521 displays the price of the new phone with new subscription plan. The field 522 displays the specification of the new phone. The field 523 displays the style of the new phone. In an example embodiment, the specification of the new phone may be visually or statistically compared in a percentage at a glance manner to the specification of the user's current associated phone in the search results table, e.g., the microprocessor speed of the new phone may be displayed as being 20% faster than the microprocessor of the current associated phone, etc. The displayed percentage may be represented as a numeric value, bar graph, line graph, color indication, etc. In an example embodiment, this result may be periodically updated, e.g., it may be updated every month, every day, hourly, multiple hour intervals, etc. This may depend on the availability of a new phone that matches with the user's search criteria, which is derived from the specification of the current associated phone. The result may be updated and an alert issued to the user, e.g., if a new phone is introduced that is 25% faster in CPU speed, etc. The result may be periodically updated without a set condition. An alert message might send to the user if the search criteria are met.

The user may click on button 530, if the user would like to start a new search. It will cause the display to display the screen in FIG. 4, for example. Button 531 saves the phone 1 search result information. The user may save the phone 1 information in local memory on computer system 30 by selecting this button. The user may retrieve the information at a later time. Button 532 saves the phone 2 search result information. The user may save the phone 2 information in local memory on computer system 30 by selecting this button. The user may retrieve the information at a later time.

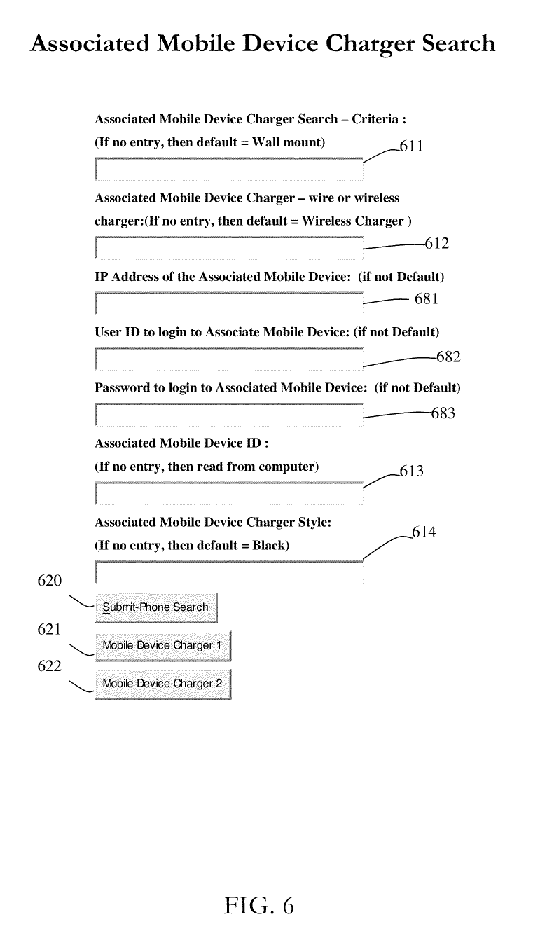

Referring to FIG. 6, another example graphical user interface is shown. In an example embodiment, the graphical user interface is a form formatted for display on display 35. There are several input boxes and buttons on the graphical user interface to accept input from the user. Data entry area 613 accepts input for an associated computer embedded object ID. The ID is an identification code to identify an associated computer's specification, based on the ID, the user may retrieve the information or the server may send the information (e.g., promotional information) to the end-user computer. The identification code of the associated computer embedded object may be Mobile Equipment Identifier (MEID). If the user doesn't know the MEID of the associated computer, the user could let application software resident on the user's computer retrieve the information, may be with an IP address 481, a user id 482 and password 483, through a computer network connection that connected to the associated computer embedded object (alternatively, this may be a default setting). The user could choose MEID as the default setting by leaving data entry area 613 empty. The current associated computer's MEID is stored in program memory 321. It could be a string of hexadecimal numbers or string of codes as discussed above. By default, the MEID is chosen unless the user inputs other ID numbers in the data entry area 613.

In an example embodiment, the current associated computer's MEID may be derived from phone number located in contact section of the user's mobile phone. User may retrieve identification or specification or phone model from contact of the user mobile phone. The phone number v.s. MEID information may stored in the data base 14, where the server 10 may be able to retrieve the information through API. Thus, part of the search criteria may be derived from the phone number located in the user mobile phone.

Data entry area 611 accepts input for a mobile device charger and search criteria. The default setting of this box may be “wall mount charger”. Data entry area 612 accepts input for a type of charger, e.g., wired or wireless. The default setting of data entry area 612 may be “wireless charger” if the user does not enter any data into data entry area 612. Processor 31 receives the user data input from data entry area 612.

Data entry area 614 accepts user data input for the mobile device charger style. In an example embodiment, the mobile device charger style is black or white. In an example embodiment, the mobile device style may be any color such as pink or blue.

Button 620 is the “submit button” for the user to click (or touch). The user may click or touch the button to submit the search criteria. Button 621 and button 622 are the memory recall buttons used to recall the mobile device charger information from a previous input or a previous search. The user may recall the mobile device charger information by clicking either the memory recall button 621 or 622.

Processor 31 organizes the received input, associated computer embedded object id, mobile device charger and search criteria, mobile charger type, mobile device charger style criteria, as a message packet or database query. In an example embodiment, processor 31 sends the information to the server via Internet Service Provider 38 using, for example, a modem 381, phone line, cable modem, DSL modem, etc. The Internet Service Provider 38 further transmits the information to server 10. After receiving the information at server 10, processor 11 forms the search query and queries database 14.

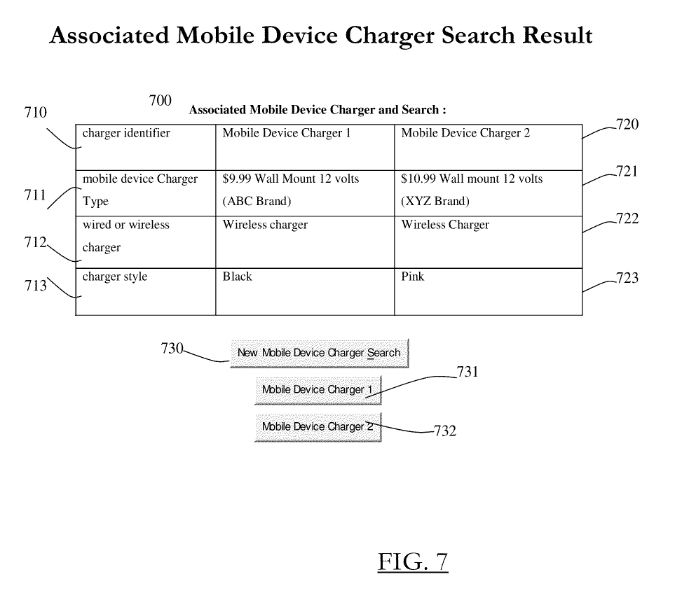

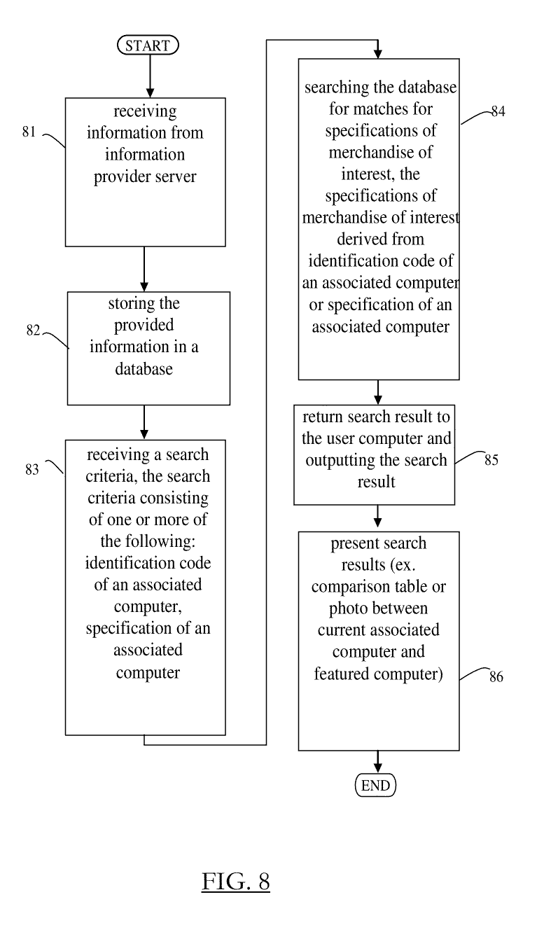

Referring to FIG. 7, processor 31 receives the search results and displays the results as 700 to the user. Search results table 700 includes a display field 710 for the charger identifier, a display field 711 for the mobile device charger type, a display field 712 to indicate if the charger is a wired charger or a wireless charger, and a display field 713 for the mobile charger style.

The search results table 700 also includes information that displays the results. Fields 720, 721, 722, 723 display results that match the search criteria. The field 720 displays the identifier of a mobile charger. Field 721 displays the price of the mobile charger and the voltage rating. The field 722 displays whether the mobile device charger is a wireless charger or a wired charger. The field 723 displays the style of the mobile charger that includes the color.

Button 730 is the new search button. The user may click on the button to start a new mobile device charger search. It will cause the display to display the screen in FIG. 6, for example. Button 731 saves the mobile charger 1 information. The user may save the mobile charger 1 information in local memory on computer system 30 by selecting this button. The user may retrieve the information at a later time. Button 732 saves the mobile charger 1 information. The user may save the mobile charger 2 information in local memory on computer system 30 by selecting this button. The user may retrieve the information at a later time.

Referring to FIG. 8, an example process flow chart is shown illustrating a server performing searches for merchandise related to an associated computing device's ID or specification. At step 81, the server 10 or a database manager receives computer device and merchandise information from computer device/merchandise manufacturers, distributors, and/or retailers. The computer device information includes information needed to populate the database with computer ID and specification information. The server 10 receives the information from the computer device/merchandise manufacturers, distributors, and/or retailers via an Internet connection, phone line, radio frequency link, etc. The computer device and merchandise information may be any combination of: manufacturer specification, operation system specification, micro processer speed specification, memory size specification, memory type specification, dimension specification, weight specification, color specification, style specification, wireless subscription plan specification, computer network connection speed specification, computer network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

The associated computer embedded object ID and specification information is correlated with merchandise object information received from the computer device/merchandise manufacturers, distributors, and/or retailers by the server 10. Server 10 may perform the correlation using local memory or may store the information (step 82) in data structures, such as tables, in database 14.

At step 83, server 10 receives search criteria such as an ID code for a computer associated with user computer or a specification of a computer associated with user computer from a user's computer. The server 10 forms a query for database 14 using the search criteria. Server 10 then submits the query to database 14. Database 14 finds any merchandise that has been correlated to match the search criteria, for example, candidate cellular phones, car chargers, cellular phone cases, earphones, etc.

At step 85, the server 10 receives the search results from database 14. Server 10 formats the search results in a message to the user's computer. The message may take many forms, e.g., a formatted HTML page, a bitmap picture, a customized or standard message packet, etc. The server 10 sends the message to the user's computer.

At step 86, the user's computer receives the message from the server 10 and displays the search results to the user. The user's computer may format a screen using the search results, display a bitmapped page, display an HTML page, etc. In an example embodiment, the user may purchase any of the merchandise shown in the search results by clicking on a purchase button near the merchandise description. In an example embodiment, a link (e.g., URL, hyperlink, etc.) may be displayed along with the merchandise description that the user may click on to obtain more information about the merchandise.

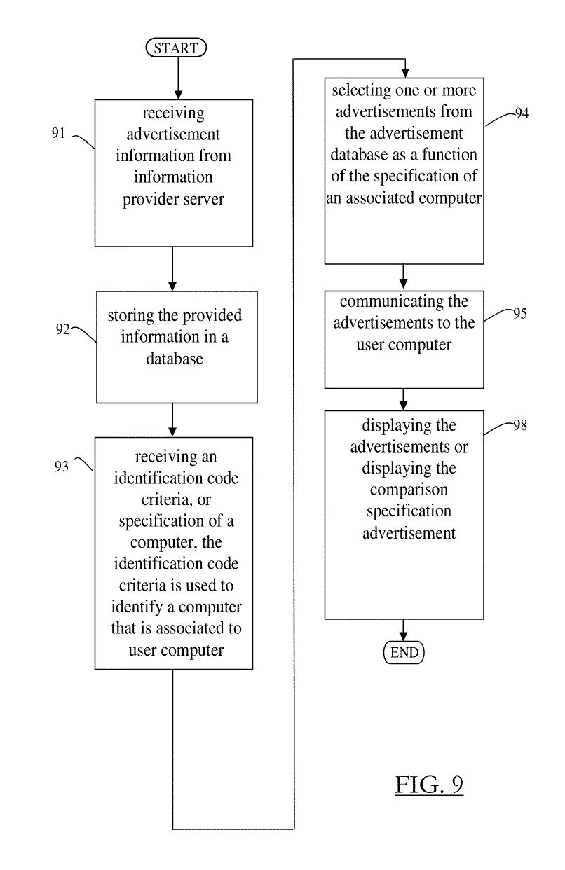

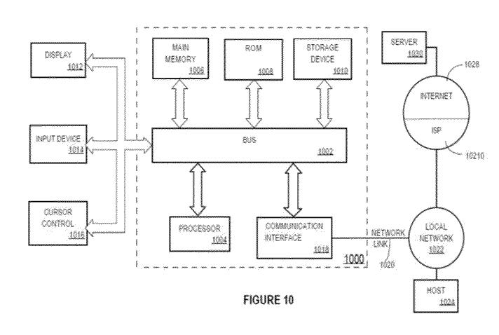

Referring to FIG. 9, an example process flow chart is shown illustrating a server performing searches for advertisements related to a computing device's ID or specification that is associated with user computer. At step 91, the server 10 or a database manager receives advertisement information from computer device/merchandise advertisers, manufacturers, distributors, and/or retailers. The advertisement information includes information needed correlate the advertisement information with the computer ID and specification information in the database. The advertisement information may also include geographic information that may restrict or exclude advertisements to certain geographic areas, for example. The server 10 receives the information from the computer device/merchandise advertisers, manufacturers, distributors, and/or retailers via an Internet connection, phone line, radio frequency link, etc.

The advertisement information received from the computer device/merchandise manufacturers, distributors, and/or retailers is correlated with computer ID and specification information by the server 10. Server 10 may perform the correlation using local memory or may store the information (step 92) in data structures, such as tables, in database 14.

At step 93, server 10 receives search criteria such as an ID code for a computer that is associated with user computer or a specification of a computer that is associated with user computer from a user's computer. The server 10 forms a query for database 14 using the search criteria. The query may take any form that is compatible with the database mechanism used, e.g., SQL query, etc. Server 10 then submits the query to database 14. Database 14 finds any advertisements that have been correlated to match the search criteria, for example, service advertisements, upcoming product advertisements, advertisements for current products with links for the user to click on, etc.

At step 95, the server 10 receives the search results from database 14. Server 10 formats the search results in a message to the user's computer. The message may take many forms, e.g., a formatted HTML page, a bitmap picture, a customized or standard message packet, etc. The server 10 sends the message to the user's computer.

At step 96, the user's computer receives the message from the server 10 and displays the search results to the user. The user's computer may format a screen using the search results, display a bitmapped page, display an HTML page, etc. In an example embodiment, the user may purchase any of the merchandise shown in the search results by clicking on a purchase button near the advertisement. In an example embodiment, a link may be displayed along with the advertisement that the user may click on to obtain more information about the subject of the advertisement.

Note that all of the operations and/or modules described herein may be implemented, individually or in any combination, in software programs, hardware, or any combination of software and hardware.

The system allows users to shop without having to log onto a carrier's website. Users are able use information readily at hand, such as the identification code of the computer that is associated with user computer or its specification, to shop for similar or better computer or mobile devices.

### 4. Automatic Page Formatting for Diverse Devices

In an example embodiment, server 10 receives associated computer embedded object IDs and specifications from a user's computer when a user searches for merchandise, advertisements, etc. The server 10 may search for the hardware and software specifications of the user's computer in database 14. With the user's computer hardware and software specifications, the server 10 has the ability to automatically customize the search results for the user's computer.

In an example embodiment, server 10 prepares a display page formatted for the specific hardware and software configuration of the user's computer. For example, the server 10 finds that the user's computer is a cellular phone with a gray scale having a screen resolution of 320×200 pixels. The search results include a color JPEG picture of a featured cellular phone as well as specifications for two cellular phones. The server 10 scales the JPEG picture to fit the 320×200 pixel screen and converts the JPEG picture to gray scale. The server 10 also formats the specification information for the two cellular phones to fit in a table form, possibly as shown in FIG. 7. The server 10 formats the table to fit in a 320×200 pixel screen. It creates an HTML page to display the formatted table and the scaled and converted JPEG picture. It then sends the page to the user's computer.

In another example, the server 10 finds that the user's computer is a desktop PC with a 16-bit color display having screen resolution of 1024×768 pixels. The search results include a JPEG picture of a featured PC as well as specifications for four PCs. The server 10 scales the JPEG picture to fit in the 1024×768 pixel resolution and 16-bit color range. The server 10 also formats the specification information for the four PCs to fit in a table form. The server 10 formats the table for the 1024×768 pixel resolution. It creates an HTML page to display the formatted table and JPEG picture and sends the page to the user's computer.

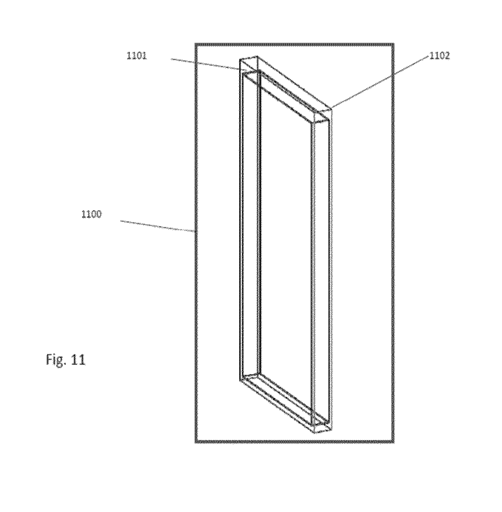

The server 10 may automatically adapt search results output and advertisements to any user computer because the computer's specifications are stored in database 14. referring to FIG. 11, server 10 may scale a comparison display using, e.g., a JPEG picture, TIFF picture, etc., to show the user a comparison of the size of the user's present associated computer embedded object or larger hardware system associated with the user's associated computer, e.g., a cellular phone, automobile, desktop computer, etc. For example, if the user's associated computer embedded object is a cellular phone, a comparison display may be scaled for the user's computer screen 1100. The display may include a depiction of the user's associated cellular phone 1101 and a suggested replacement of the associated cellular phone 1102. The outline of both of the cellular phones may be visually, pictorially, or graphically overlaid on top of each other on a display. The display may also include a rotate and/or zoom capability. The specification of both of the phones may be compared side by side in a table format, or may be overlaid in the display format. Moreover, the comparison specification of the replacement and the current cellular phone may be delivered to the user in any of the following formats: audio format, video display format, picture display format, text display format, etc.

In an example embodiment, the server 10 may create different resolution pages that adapt to the connection bitrate of the user's computer in order to make the transfer of the search information to the user computer more efficient. For example, the server 10 may find that the user's computer is a cellular phone on a data communication computer network using 3 G technology. The server 10 formats the resolution of the search results HTML page to take as little bandwidth as possible in order to give the user a better user experience.

### 5. Revenue Generation

In an example embodiment, server 10 as the ability to record which advertisements are sent to a user's computer. The server 10 may charge an advertiser a fee for every advertisement sent out to users' computers using an accounting software package. Alternatively, the server 10 may notify an accounting server of advertisements sent to users' computers. The accounting server may charge fees to advertisers based on, for example, the number of times the advertiser's advertisements are sent out.

In an example embodiment, the user's computer acts in conjunction with server 10 to record advertisement views, link click-throughs, search result selections, etc. The user's computer records which of the search results the user selects. The user's computer may also record whether the user selects or views any advertisements sent by the server 10. The server 10 receives information from the user's computer indicating which search results were selected by the user and, in addition to or alternatively, any advertisements selected or viewed by the user. The server 10 may charge the subject of the selected search result (e.g., a service) a fee for being selected by the user using an accounting software package. The server 10 could charge an advertiser a fee for every advertisement selected or viewed by users. Alternatively, the server 10 may notify an accounting server of selected search results. The accounting server may charge fees to the subject of each selected search result. Server 10 could notify an accounting server of advertisement selected or viewed by users. The accounting server may charge fees to advertisers based on, for example, the number of times the advertiser's advertisements are selected or viewed.

In an example embodiment, the server 10 or an accounting server may charge an advertiser a fee for preferential selection of advertisements for a specific geographical area. The server 10 will select the advertiser's advertisement(s) for a certain number of queries, for example, that originate from a certain geographical area.

### 6. Social Networking Services

Social networking is becoming popular as a way to communicate information between linked users. Examples of social networking services are LinkedIn, Facebook, Google plus. These types of services allow a user to communicate with other linked users for a variety of reasons. A system and method in accordance with an embodiment may be utilized advantageously to provide enhanced value for such a communication. This may be accomplished through the sharing of identification information, specification, or made and model of a computer embedded object such as a smart phone, laptop, tablet or other type of electronic device.

The sharing of identification information may be accomplished in a variety of ways. For example a database, e.g., a portion of the database 14, may be constructed utilizing the identification information of the computer embedded objects of the plurality of users on the social networking service. For example the identification information of the computer embedded object may be IMEI of the computer embedded object. In addition, the user identification of each of the plurality of users of the social networking may also be within the database. In one embodiment, an operator of the social networking service may access the information related to the computer embedded object of each user in the computer network. Such information may be located in a centralized database. In another embodiment, the information may be located in a distributed database wherein a portion of the information is stored within the computer embedded object of each user.

Database

A database for the social networking service may be built from the plurality of computer embedded objects to enhance the utility of the present invention in social networking environment. In a example, the database preferably may be queried by a user or a service provider. In another example, database mining techniques of such a database may be used by a server provider or a user. For an example a mobile handset manufacturer may be able to access the database to obtain the correlation information between mobile handset model and viewing statistics of a text message. For an example the correlation may between the model number of the mobile handset and the length of the text message. One of ordinary skill in the art recognizes many types of correlation that could be provided and they would be within the spirit and scope of the present invention.

In an embodiment, a method and system for collecting data of a plurality of users participating in a social networking service is disclosed. The method and system includes a server, such as the before described server 10. Each of the plurality of users has a computer embedded object. In an embodiment, a database is built within the server 10 utilizing information from the computer embedded objects. The database may query the embedded objects in a predetermined to obtain information related to the embedded objects. For example if information is missing from the database, the database may query the computer embedded objects on a periodic basis to obtain the missing information. In another example data mining techniques may be utilized by the server 10 to examine the database. In yet another example, data management systems may be utilized by the server 10 to examine the database.

Accordingly, in a first aspect a computer implemented method or system for use with a social networking service includes receiving information relating to the computer embedded object of a first user of the social networking service; and sending the information of the computer embedded object to a second user for display. In so doing information about the computer embedded object of the first user is available to the second user.

In another aspect, comment information related to an identification code of the first user may be received by the other users linked to the first user. The comment information comprises for example any or any combination of information about the usage experience of the first user, a log file of the computer embedded object, a tweet, is located in a fan page

In yet another aspect, comment information related to the identification code from the computer embedded object of a second user is sent to the first user for display. The comment information comprises for example any or any combination of information about the usage experience of the first user, a log file of the computer embedded object, a tweet, is located in a fan page.

In another aspect, an identification code is derived from a hostname of the computer embedded object and an identity authenticating password. The identity authenticating password and the hostname of the computer embedded object is used for accessing the identification code stored in the computer embedded object.

In another aspect, a computer implemented method of sharing identification information relating to of a computer embedded object of a plurality of users participating in a social networking service is disclosed. The method comprises receiving a list of identification codes of a group of computer embedded objects from a group of users of the social networking service. The method further includes grouping the list of identification codes according to an internet service provider and comparing a promotion carrier service to the internet service provider service and providing promotion information. Finally the method includes sending promotion information based on the grouping to the list of users for display

In yet another aspect, a computer implemented method of sharing an identification code of a computer embedded object of users participating in a social networking service is disclosed. The method comprises receiving a list of identification codes of a group of computer embedded objects from a group of users of the social networking service and grouping the list of the identification codes according to a service provider. The method includes comparing a promotion carrier service to the service provider service and sending promotion information of the promotion carrier service based on the grouping to the group of users for display.

Accordingly, users may be grouped together in accordance with certain parameters. To describe this feature refer now to the following description.

Grouping

In one embodiment, user information may be collected from user's interested in the offer in accordance with the identification code or the associated specification of the computer embedded objects of the interested users stored in the database. Accordingly, the users with the identification code or appropriate specification may sign in or receive the discount information or offer information. In an example embodiment, consumer information may include information for user, such as any of or any combination of: promotion information, advertisement information, business directory information, sales information, coupons.

In addition, the level of the discount may be correlated to the number of users that have the appropriate specification to receive the discount. Once again, this information is derived from a certain specification, identification code or model number or other parameter of the computer embedded object.

Grouping Statistics

In a yet another embodiment, an operator of the social networking service may be able to deliver the information according to a group identification for a plurality of users computer embedded objects. Information that could be delivered includes but is not limited to coupon information, advertisement information or the like. In addition, in a system and method in accordance with the present invention more than one parameter may be extracted from a computer embedded object. For example, the server 10 might be able to obtain specification parameters from one user within a group by referring to an identification code of another user within the group. The information (offer) may be able to set according to the number of the user in the group. Some grouping statistics that may be used are Age v. phone model or Age v.s. specification. In this type of system a first parameter may be for the existing data base (age) and the second parameter may be from the computer embedded object. (id). Thereafter a correlation between first and second parameter may be provided to ensure that the data may be provided to the appropriate computer embedded objects. The server 10 may then combine these two parameters one from computer embedded object and the other from the database to provide any type of service, product, discount, advertising or the like information to the user.

### 7. Examples of Possible Embodiment

In an example embodiment, a user might include information related to a user, which might include but not limited to user's age, sex, occupation, name, email address, phone number, computer model or computer identification code or computer specification that owned or used by the user. In an example embodiment, a device list might include a list of the devices that own, used, or computer network connected by the user. The device may be a computer embedded object or an associated computer embedded object. The list of the device might include but not limited to the identification code, specification, usage, service history, or computer network login history of a computer embedded object or device. The device list might have category include, but not limited to, home device sub list, work device sub list, mobile device sub list, or a network connected television sub list.

In an example embodiment, a server may deliver consumer information, wherein the consumer information derived from a device list profile of a first user, which the device list may include at least one of identification code, specification, or configuration of the computer embedded objects that may be collected by the first user from a computer network. Optionally the information may derive from a first user computer, manually entere by the first user, from the first user's purchasing history, from billing history of the first user, from first user device internet search history, or from first user's internet browsing history of computer devices. The first user's device activity history may include but not limited to device power on and off history, login history, download history, battery charging history, bandwidth usage history, memory usage history, email history, user blog history, or computer embedded object power consumption history. The consumer information of a computer embedded object may be delivered to the second user by a server using one of the following method but not limited to: inferred or extrapolated preference of the first user based on the device list profiles of the first user, or explicitly asking the second user for preferences based on the first user's device list profile.

In an example method embodiment of the invention, the first user may create a new device list by adding a first device list of identification codes into a second device list identification codes of computer embedded objects. The two device lists may be combined by concatenating or merging selected information from the first device list to the second device list. The third list, new list, may be created and be stored as part of the user device list profile. Information to be received by the user may derive from the new, third list. The statistical data may be extracted from the third list, e.g., the average value of a parameter such as the microprocessor speed of the computer embedded objects in the third list. The third list may be processed to obtain statistical information such as, but not limited to, an average value of a selected parameter, a mean value, a standard deviation, and other statistical calculation. The server may process an identification code from the third list to obtain a description from a database e.g., database 14 that matches the identification code. The information may be delivered to the user computing device, from the server. The sent information is related to the merchandise of interest, the sent information derived from the description obtained from the database. The description of a computer embedded object may be an identification code, specification or a text description of a computer embedded object. The merchandise of interests may be any indication that the user may be interested in the merchandise. The merchandise of interests may be included in the following format but not limited to: a search criteria, a web page, a selection of the information, or a user profile.

In an example embodiment, the system delivers information to a user, based on the specification or ID of the associated object that is computer network connected to the object that interacts with the user, where a portion of the information is derived from the specification or ID of the associated object that is not manually input by the user. The information may be related to one of the following information group consisting of: merchandise information (including, but not limited to: the information or the price information related to a vehicle or an auto part, information or price information related to a mobile device, information or price information related to an object equipped with a computer, information or price information related to a component or a tool to build an object equipped with a computer), advertisement information (including, but not limited to: advertisement information or on sale information related to a vehicle or an auto part, advertisement information or on sale information related to a mobile device or an accessory of a mobile device, advertisement information or on sale information related to an object equipped with a computer, information of on sale information related to a service to an object equipped with a computer (e.g., an auto repair service, etc.)), and service information (including, but not limited to: service information, repair information, or service/repair labor cost information related to a vehicle, service information or wireless plan service related to a mobile device, service information, repair information, or service/repair labor cost information related to an object equipped with a computer).

In an example embodiment, the associated object is associated with a larger hardware system, such as a vehicle, e.g., car, motorcycle, boat, ship, airplane, etc. The hardware specification information may be retrieved from the license plate number or VIN (Vehicle Identification Number) of the vehicle that the user is interacting with. The information may also be retrieved from the ID or specification of the mobile device installed in the vehicle. In an example embodiment, the user may obtain the license plate number or VIN from images, e.g., a picture, a photo, etc., of the vehicle's license plate from a mobile device, e.g., a cell phone equipped with camera, a camera with a wireless connection, etc. The mobile device may transfer the image to the object in the vehicle via, for example, a wireless connection such as Bluetooth or 802.xx, a media card such as an SD card or USB pen drive, etc. The information from the image might be obtained using, for example, OCR (Optical Character Recognition) or any process that converts images of text into characters. After conversion, the license plate number or VIN may be used as the ID or specification of the vehicle. The mobile device could perform the OCR on the image before sending the text information the server 10 or the server 10 may perform the OCR upon receipt of the image from the mobile device.

In an example embodiment, the license plate number or VIN of the vehicle may be obtained from a user profile, which is stored in a database. In that case, the search result is derived from the user profile which stores the ID or specification of an object (in this example, a vehicle). In one possible case, the user profile consists of a list of the ID or specification of the associated objects.

Upon receipt of the vehicle ID or specification, the server 10 searches the database 14 for the ID or specification. The information that the database 14 returns includes information about the associated vehicle. The information comprises details about the vehicle that the server 10 may use to find merchandise information, advertisements, and/or service information related to the vehicle. For example, the information returned from a search could include the following:

a. Type of Vehicle: 2010 XYZ brand 4 door sedan.

b. Operating System: Any operating system for the computer installed in the automobile.

c. Horse Power: 210 horse power.

d. Engine: 6 cylinder, 2000 CC

In an example embodiment, the user may shop for a vehicle that is similar to the associated vehicle that is computer network connected to the computer from which the user has initiated the inquiry. The server 10 searches the database 14 for vehicles with similar information as the associated vehicle that is computer network connected to the computer from which the user has initiated the inquiry. The server 10 returns the search results to the user computer.

In an example embodiment, the system allows a user to search for replacement parts for an associated vehicle. In one possible example, the user may shop for brake pads associated with the associated vehicle. The server 10 may query the database 14 for brake pads for the associated vehicle using the ID or specification supplied by the associated vehicle. The information returned from the search may include the following:

Brake Pad Specification:

Part Number: MKD465A (ABC Brake Brand for XYZ car Brand)

Weight: 3.1 lbs

Warranty: Limited Lifetime

Notes: Semi-metallic

Friction Material Type: Platform specific friction

Wear Sensor: Yes

Friction: No

In an example embodiment, the user may search for a service or repair service, possibly including the labor cost, of the associated hardware that the user's computer is connected to. In an example embodiment, the user may shop for an installation service that will install the brake pads related to the vehicle.

In an example embodiment, the user may search for DYI (Do-It-Yourself) and “how to” service/installation/repair information related to the associated hardware that the user's computer is connected to. In an example embodiment, the user may search for information about “how to install brake pads” related to the vehicle. The “how to” information might include, but is not limit to, the following: the price of the tool, type of tool, the dimensions (metric or SAE) of the screws/washers, type of lubricants needed to install brake pads. The “how to” information might include the price of any associated tools or any other components that are needed to install the necessary component or perform the necessary service.

In an example scenario, a user interacts with a computer, user computer, that is computer network connected to an onboard computer in a 2007 XYZ automobile, associated automobile. The automobile has a factory wireless computer network adaptor that the onboard computer uses to access the computer network with a user computer. The user initiates a search from the user computer for a service to perform an oil change on the associated automobile. The onboard computer has been programmed by the factory with the automobile's VIN number. The onboard computer sends the VIN number to the user computer, through internet, and the user computer send both VIN number and the request for an oil change service to the server.

The server receives the VIN number from the associated automobile and the request for an oil change service from the user computer. The server uses the VIN number to search the database for the automobile information. The database returns the following information:

a. Type of Vehicle: 2007 XYZ brand sport coupe.

b. Operating System: Windows CE.

c. Horse Power: 300 horse power.

d. Engine: 6 cylinder, 3500 CC

The server then searches the database for an XYZ oil change service center. The server may also search the database for advertisements for oil change services for the XYZ automobile. The server returns the search results for oil change service centers (and possibly the advertisements from the advertisement search) to the user computer.

The user computer displays the oil change service center search results to the user (and possibly any advertisements received from the server). The user computer may offer the user the option of selecting an oil change service center and displaying directions and/or a map for the oil change service center. The user computer may monitor which oil change service center the user selects (the simple selection from the search results). The user computer may inform the server or a monitoring service of the oil change service center selected by the user. The server, accounting system, or monitoring service may then charge the oil change service center a fee for the referral.

The user computer could also monitor whether the user selects any of the advertisements that the user computer has displayed to the user. The user computer may inform the server or monitoring service of the advertisement selected by the user or displayed to the user. The server, accounting system, or monitoring service may then charge the advertiser a fee for the selection or display.

In an example embodiment, a comparison specification of the replacement car and the current associated car may be delivered to a user. The comparison specification may include, but is not limited to: percentage increase or decrease of the engine capacity, percentage increase or decrease of the horsepower of the replacement car over the current associated car, percentage increase or decrease of the torque of the replacement car over the current associated car, benefit of the type of the replacement car vs. the current associated car, etc.

In another example scenario, a user interacts with a cellular phone with respect to a 2007 XYZ automobile. The cellular telephone has access to the Internet and a server (for example, like server 10 described above) using a cellular communications link (e.g., 3 G, 4 G, CDMA, etc.). The user takes a picture, using the cellular phone, of the automobile's VIN. The user then initiates a search for a tire repair service for the automobile. The cellular phone sends the picture of the VIN number to the server and a request for a tire repair service.

The server receives the picture of the VIN number and the request for a tire repair service from the cellular phone. The server performs an OCR process on the picture and obtains the VIN number. The server uses the VIN number to search the database for the automobile information. The database returns the following information:

a. Type of Vehicle: 2007 XYZ brand sport coupe.

b. Operating System: Windows CE.

c. Horse Power: 300 horse power.

d. Engine: 6 cylinder, 3500 CC

The server then searches the database for a tire repair service center. The server may also search the database for advertisements for tire repair services. The server returns the search results for tire repair service centers (and possibly the advertisements from the advertisement search) to the cellular phone.

The cellular phone displays the tire repair service center search results to the user (and possibly any advertisements received from the server). The cellular phone may offer the user the option of selecting a tire repair service center and displaying directions and/or a map for the tire repair service center. The cellular phone may monitor which tire repair service center the user selects (possibly via monitoring the navigation system or the simple selection from the search results). The cellular phone may inform the server or a monitoring service of the tire repair service center selected by the user. The server, accounting system, or monitoring service may then charge the tire repair service center a fee for the referral.

The cellular phone could also monitor whether the user selects any of the advertisements that the onboard computer has displayed to the user. The cellular phone may inform the server or monitoring service of the advertisement selected by the user or displayed to the user. The server, accounting system, or monitoring service may then charge the advertiser a fee for the selection or display.

For the purposes of illustration, merchandise information have been used in the examples below, but may be substituted with any information from the following information group consisting of: merchandise information (including, but not limited to: the information or the price information related to a vehicle or an auto part, information or price information related to a mobile device, information or price information related to an object equipped with a computer, information or price information related to a component or a tool to build an object equipped with a computer), advertisement information (including, but not limited to: advertisement information or on sale information related to a vehicle or an auto part, advertisement information or on sale information related to a mobile device or an accessory of a mobile device, advertisement information or on sale information related to an object equipped with a computer, information of on sale information related to a service to an object equipped with a computer (e.g., an auto repair service, etc.)), and service information (including, but not limited to: service information, repair information, or service/repair labor cost information related to a vehicle, service information or wireless plan service related to a mobile device, service information, repair information, or service/repair labor cost information related to an object equipped with a computer).

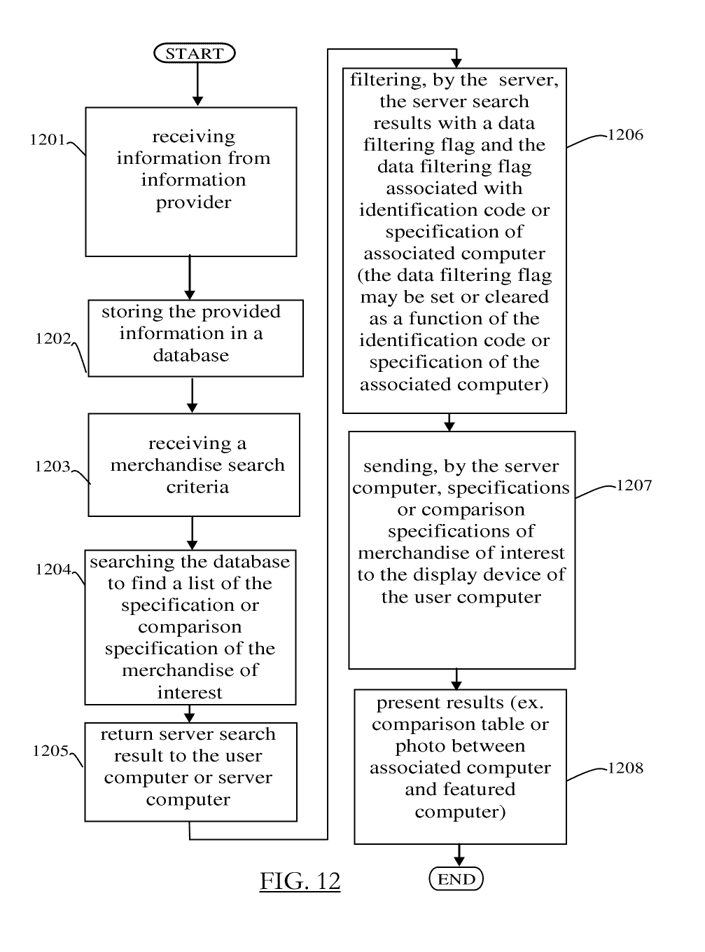

Referring to FIG. 12, an example process flow chart is shown illustrating a server performing filtering of merchandise search result in order to find merchandise related to an associated computing device's ID or specification. The associated computer embedded object may be computer network connected to the computer that user interact with.

At step 1201, the server 10 or a database manager receives computer device and merchandise object information from computer device/merchandise manufacturers, distributors, retailers, etc., via an Internet connection, phone line, radio frequency link, etc. The computer device information includes information needed to populate the database with computer ID and specification information. The computer device and merchandise information may be any combination of: manufacturer specification, operation system specification, micro processer speed specification, memory size specification, memory type specification, dimension specification, weight specification, color specification, style specification, wireless subscription plan specification, computer network connection speed specification, computer network connection type specification, display technology specification, display size specification, display resolution specification, software revision specification, connection coverage availability specification, connection technology specification, battery type specification, camera resolution quality specification, ability to customized specification, keyboard type specification, GPS availability specification, etc.

The computer ID and specification information is correlated with merchandise object information by the server 10. Server 10 may perform the correlation using local memory or may store the information (step 1202) in data structures, such as tables, in database 14. A comparison specification database, comparing the specification between the provided merchandise information, may be generated.

At step 1203, server 10 receives search criteria such as merchandise search criteria from a user's computer. The server 10 queries database 14 using the search criteria (step 1204). Database 14 finds any merchandise matches the search criteria, for example, candidate cellular phones, car chargers, cellular phone cases, earphones, vehicle, etc.

At step 1205, the server 10 receives the search results after the search of the database 14. Alternatively, the user's computer receives the search results from the server 10 after the search of the database 14

At step 1206, the search results may be filtered by a mechanism on the server 10 (or, alternatively, on the user's computer) as a function of the user's associated computing device's ID or specification. For example, the server search results may be filtered with the following requirement: only objects with more than a 10% microprocessor speed increase over the user's associated computer embedded object remain in the final/display dataset that is sent to the user computer for display.

The server search results may be filtered by a mechanism as a function of the user associated computing device's ID or specification. For example, the server search results may be filtered by the following requirement: only merchandise with more than a 10% increase in microprocessor speed over the user's associated computer embedded object remain in the final/display dataset that is displayed to the user. Thus, an additional step to FIG. 8 may be added—server search results may be filtered by a mechanism as a function of the user associated computing device's ID or specification. The server search results may be filtered by a display flag. The display flag may be set, by the server, for example, if the microprocessor speed of the comparison specification or specification of the computer merchandise of interest is greater than 10% faster than the user's current associated computer's microprocessor speed. This may be implemented by a conditional and compare function to generate the final/display dataset.

In a possible process flow, the server 10 formats the information according to the user's associated computer embedded object ID or specification. In this example, the merchandise computer with a 10% faster speed than the speed of the user associated computer's microprocessor speed may be displayed to the user, due to the cookie being set by the server 10. The “10% faster speed than the speed of the user associated computer's microprocessor speed” may be the condition for display.

In a possible process flow, the user's computer formats the display information according to the user's associated computer embedded object ID or specification. This may be implemented by display control software, such as a browser, that generates a cookie and/or retrieves a cookie, with the cookie being a function of the user associated computer's ID or specification. The information to be displayed in the user computer's display monitor may be a function of the user associated computer's ID or specification. In this example, the merchandise computer with a 10% faster speed than the speed of the user associated computer's microprocessor speed may be displayed to the user, due to the cookie being set by the server 10. The “10% faster speed than the speed of the user associated computer's microprocessor speed” maymay be the condition for display.

At step 1207, the server 10 sends, as a function of the specification or identification code of the user's associated computer, the specifications or comparison specifications of the merchandise to the user's computer. Alternatively, the user's computer has previously formatted the display information.

At step 1208, the user's computer receives the message from the server 10 and displays the search results to the user. Alternatively, the user's computer has previously formatted the display information. The user's computer may format a screen using the search results, display a bitmapped page, display an HTML page, etc. In an example embodiment, the user may purchase any of the merchandise shown in the search results by clicking on a purchase button near the merchandise description. In an example embodiment, a link (e.g., URL, hyperlink, etc.) may be displayed along with the merchandise description that the user may click on to obtain more information about the merchandise.

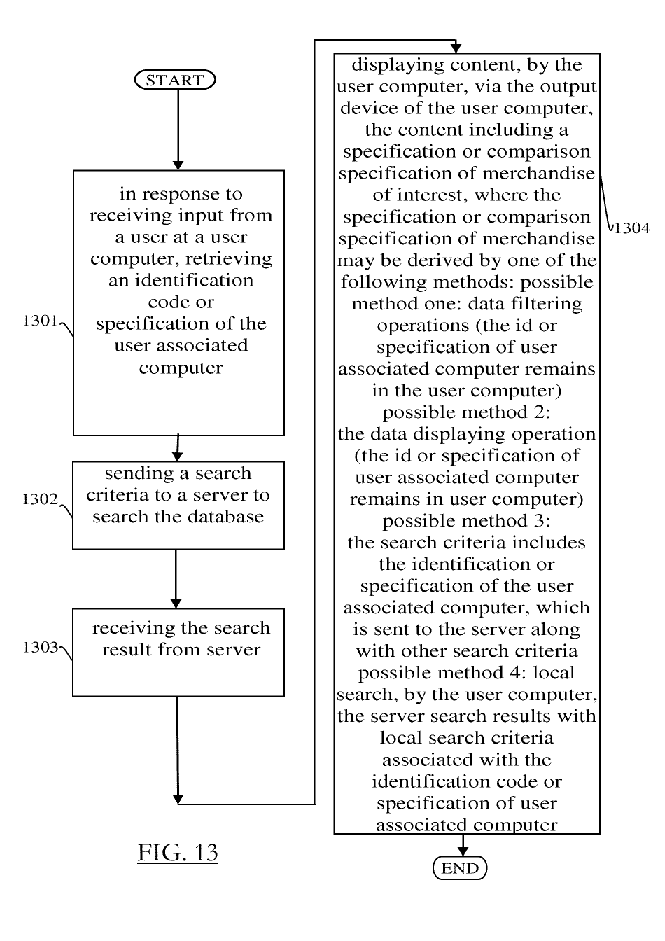

Referring to FIG. 13, an example process flow chart is shown illustrating a user computer performing filtering of merchandise search result in order to find merchandise related to an associated computing device's ID or specification. The associated computing device may be computer network connected to the user computer.

The server search results may be filtered, by a mechanism as a function of the user associated computing device's ID or specification. For example, the server search results may be filtered by the following requirement: only merchandise with more than a 10% increase in microprocessor speed remain in the final/display dataset that is displayed to the user. The server search results may be filtered by a display flag. The display flag may be set, by the server, for example, if the microprocessor speed of the comparison specification or specification of the computer merchandise of interest is greater than 10% faster than the user's current associated computer's microprocessor speed. This may be implemented by a conditional and compare function to generate the final/display dataset.

In a possible process flow, the server 10 formats the user's computer display and/or displays the information according to the user's associated computer embedded object ID or specification. This may be implemented by user computer display control software, such as a browser, that generates a cookie and/or retrieves a cookie, with the cookie being a function of the user associated computer's ID or specification. The information to be displayed in the user computer's display monitor may be a function of the user associated computer's ID or specification. In this example, the merchandise computer with a 10% faster speed than the speed of the user associated computer's microprocessor speed may be displayed to the user, due to the cookie being set by the server 10. The “10% faster speed than the speed of the user associated computer's microprocessor speed” may be the condition for display.

At step 1301, the user computer 30 in response to a user interaction, retrieves the identification code or specification from any of: memory, disk, device, or microprocessor. The identification code or specification maybe delivered to the memory, disk, or microprocessor through a computer network from the computer with the identification code or specification. The computer with the identification code or specification may be associated with the computer, user interact with, through a computer network.

At step 1302, the user computer 30 sends search criteria to the server to search a database for information that user is looking for.

At step 1303, the user computer 30 receives the search results from server computer. The return search results may include a specification criteria.

At step 1304, the user computer 30 displays, as a function of the specification or identification code of the user associated computer, the specifications or comparison specifications of the merchandise to the user's outputting device. Four example process flows are as follows:

1. The final/display dataset may be generated at the user's computer. The server search results may be filtered, by a mechanism as a function of the user associated computing device's ID or specification. For example, the server search results may be filtered by the following requirement: only objects with more than a 10% increase over the microprocessor speed of the user's associated computer embedded object increase will be remain in the final/display dataset that will be display to the user's display. The server search results may be filtered by a display flag. The display flag may be set, by the server, for example, if the microprocessor speed of the comparison specification or specification of the computer merchandise of interest is greater than 10% faster than the user's current associated computer's microprocessor speed. This may be implemented by a conditional and compare function to generate the final/display dataset.

2. The display dataset may not be generated and data display operation may be needed. The user computer 30 formats the user's display 35 and/or displays the information according to the user's associated computer embedded object ID 37 or specification. This may be implemented by display control software, such as a browser, that generates a cookie and/or retrieves a cookie, while the cookie is a function of the user's associated computer embedded object ID 37 or specification. The information to be displayed on the user's computer display is a function of the user's associated computer embedded object ID 37 or specification. In this example, the microprocessor speed of the merchandise with 10% faster speed than the speed of the user associated computer's microprocessor speed may be displayed to the user, due to the cookie being set by the user computer 30 or server computer 10.

3. A second search step may be added. The second search step searches the searching results returned from server, based on the user associated computer embedded object ID 37 or specification. Hence, the most relevant search result, a comparison specification or a specification of the merchandise of interest, may be output to the output device of the user computer.

In this case, the ID or specification of the user associated computer embedded object remains in the user computer. The user computer does not send user associated computer embedded object related data to the server in order to prevent any privacy issues—the server does not have a copy of user's associated device record.

4. The user computer 30 displays the specification or comparison specification of the merchandise of interest from the search results received from server on the display 35 of the user computer. The search criteria, along with the ID or specification of the user associated computer, may be sent to the server computer by default. In this case, at step 1302, the search criteria contain the ID or specification of the user associated computer embedded object. At step 1303, the specification or comparison specification of the merchandise of interest is received from server. At step 1304, the results are set to the output device of the user computer.

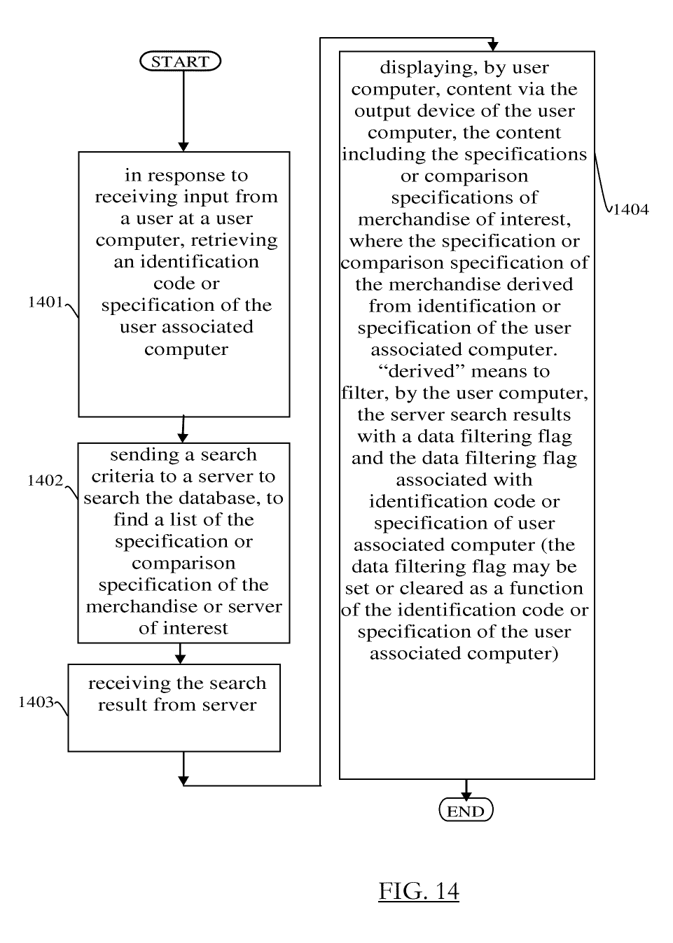

Referring to FIG. 14, an example process flow chart is shown further illustrating the first example process flow of FIG. 13.

At step 1401, the user computer 30, in response to a user interaction, retrieves the identification code or specification from any of: memory, disk space, device, or a microprocessor.

At step 1402, the user computer 30 sends search criteria to the server to search a database for information that user is looking for.

At step 1403, the user computer 30 receives the search results from server computer. This search results may include a specification criteria of computer merchandise.

At step 1404, the user computer 30 displays, as a function of the specification or identification code of the user associated computer, the specifications or comparison specifications of the merchandise on the user computer's display device.

The server search results may be filtered, by a mechanism as a function of the user associated computing device's ID or specification. For example, the server search results may be filtered by the following requirement: only merchandise with more than a 10% increase in microprocessor speed remain in the final/display dataset that is displayed to the user. The server search results may be filtered by a display flag. The display flag may be set, by the server, for example, if the microprocessor speed of the comparison specification or specification of the computer merchandise of interest is greater than 10% faster than the user's current associated computer's microprocessor speed. This may be implemented by a conditional and compare function to generate the final/display dataset.

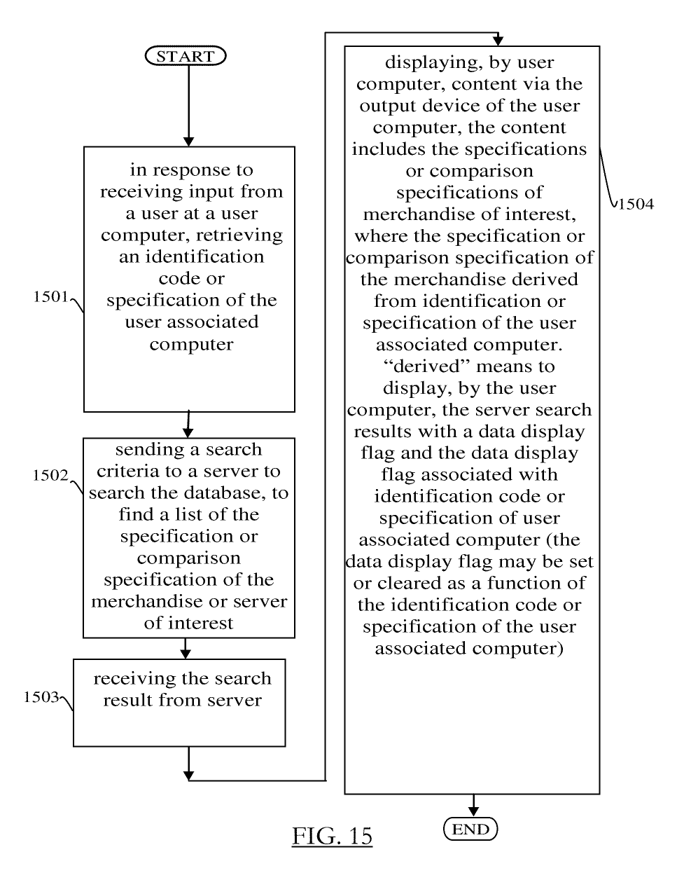

Referring to FIG. 15, an example process flow chart is shown further illustrating the second example process flow of FIG. 13.

At step 1501, the user computer 30, in response to a user interaction, retrieves the identification code or specification from any of: memory, disk space, device, or a microprocessor.

At step 1502, the user computer 30 sends search criteria to the server to search a database for information that user is looking for.

At step 1503, the user computer 30 receives the search results from server computer. This search results may include a specification criteria of computer merchandise.

At step 1504, the user computer 30 displays, as a function of the specification or identification code of the user associated computer, the specifications or comparison specifications of the merchandise on the user computer's display device.

At step 1504, the display dataset may not be generated and data display operation may be needed. The user computer 30 formats the user's display 35 and/or displays the information according to the user's associated computer embedded object ID 37 or specification. This may be implemented by display control software, such as a browser, that generates a cookie and/or retrieves a cookie, while the cookie is a function of the user's associated computer embedded object ID 37 or specification. The information to be displayed on the user's computer display is a function of the user's associated computer embedded object ID 37 or specification. In this example, the microprocessor speed of the merchandise with 10% faster speed than the speed of the user associated computer's microprocessor speed may be displayed to the user, due to the cookie being set by the user computer 30.

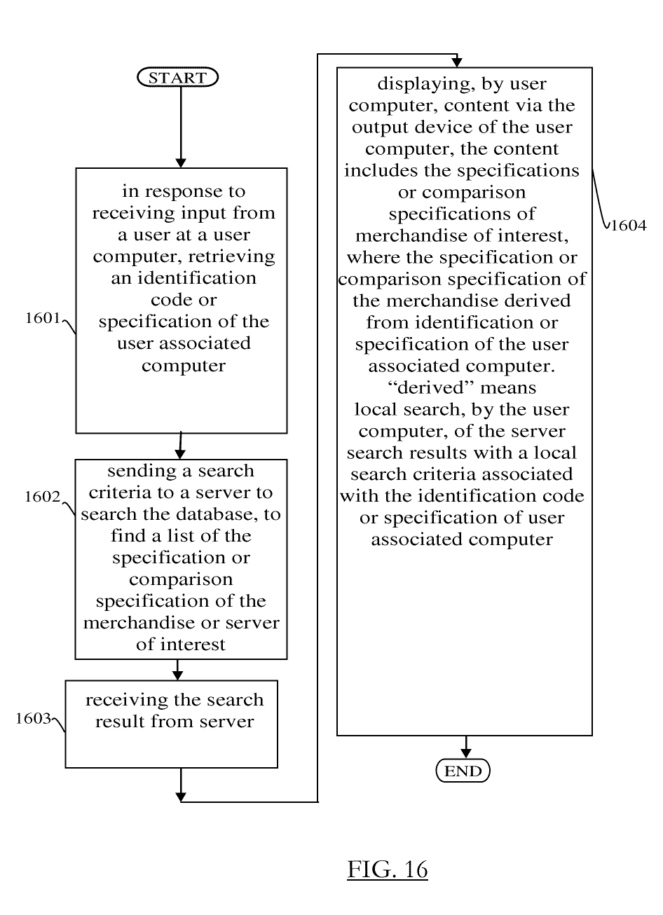

Referring to FIG. 16, an example process flow chart is shown further illustrating the third example process flow of FIG. 13.

At step 1601, the user computer 30, in response to a user interaction, retrieves the identification code or specification from any of: memory, disk space, device, or a microprocessor.

At step 1602, the user computer 30 sends search criteria to the server to search a database for information that user is looking for.

At step 1603, the user computer 30 receives the search results from server computer. This search results may include a specification criteria of computer merchandise.

At step 1604, the user computer 30 displays, as a function of the specification or identification code of the user associated computer, the specifications or comparison specifications of the merchandise on the user computer's display device.

At step 1604, second search step may be added. The second search step searches the searching results returned from server, based on the user associated computer embedded object ID 37 or specification. Hence, the most relevant search result, a comparison specification or a specification of the merchandise of interest, may be output to the output device of the user computer.

The ID or specification of the user computer remains in the user computer. The user computer does not send user computer related data to the server in order to prevent any privacy issues—the server does not have a copy of user's device record.

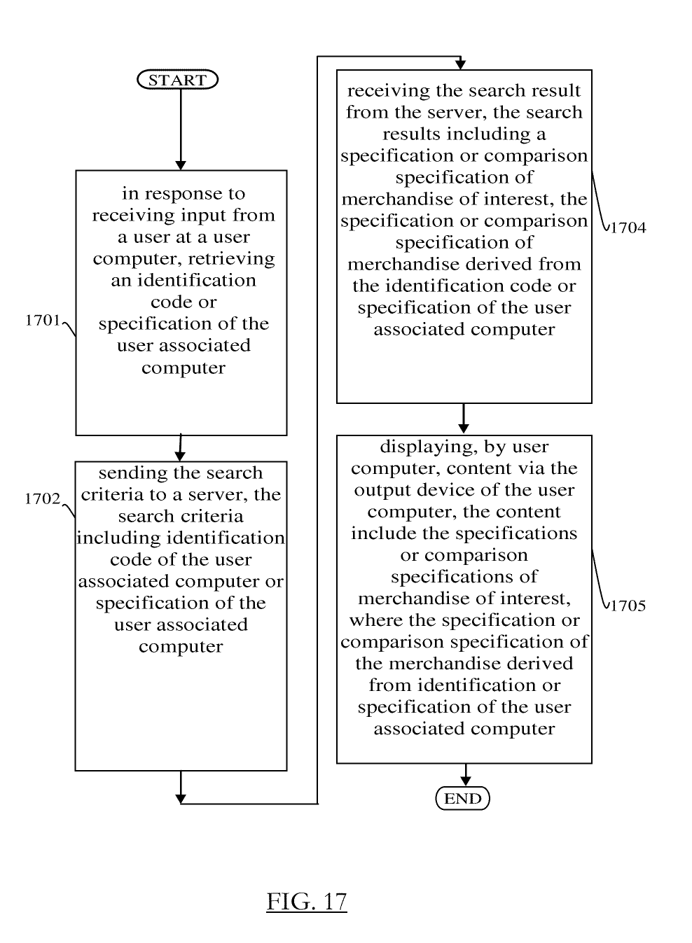

Referring to FIG. 17, an example process flow chart is shown further illustrating the fourth example process flow of FIG. 13.

At step 1701, the user computer 30, in response to a user interaction, retrieves the identification code or specification from any of: memory, disk space, device, or a microprocessor.

At step 1702, the user computer 30 sends search criteria to the server to search a database for information that user is looking for.

At step 1703, the user computer 30 receives the search results from server computer. This search results may include a specification criteria of computer merchandise.

At step 1704, the user computer 30 displays, as a function of the specification or identification code of the user associated computer, the specifications or comparison specifications of the merchandise on the user computer's display device.

At step 1704, the user computer 30 displays the specification or comparison specification of the merchandise of interest from the search results received from server on the display 35 of the user computer. The search criteria, along with the ID or specification of the user associated computer, may be sent to the server computer by default. In this case, at step 1702, the search criteria contain the ID or specification of the user associated computer embedded object. At step 1703, the specification or comparison specification of the merchandise of interest is received from server. At step 1704, the results are set to the output device of the user computer.

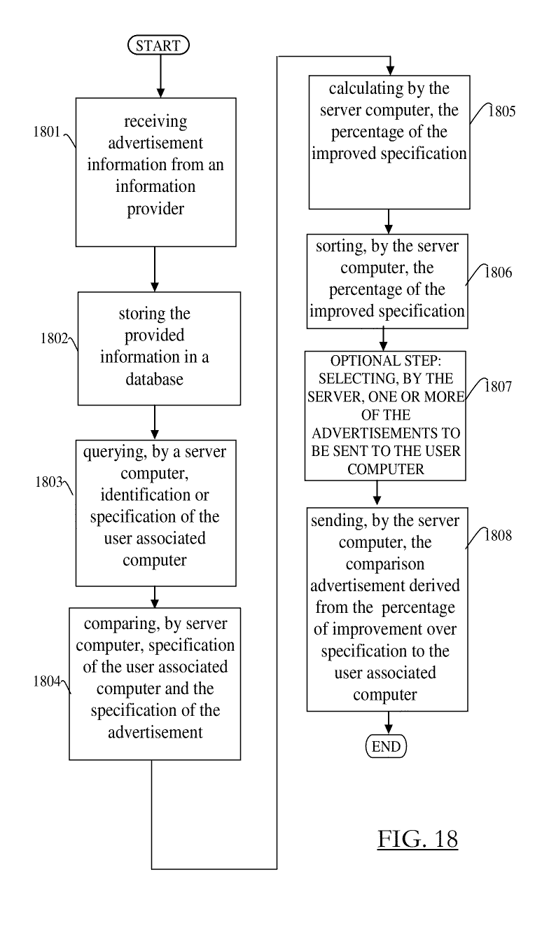

Referring to FIG. 18, an example process flow chart is shown illustrating a server delivering advertisement information related to a associated computing device's ID or specification. At step 1801, the server 10 or a database manager receives computer device and advertisement information from computer device/merchandise/advertisement manufacturers, distributors, retailers, etc. The computer device advertisement information includes advertisement information needed to populate the database with computer ID and specification information.

The server 10 receives computer device and merchandise object information from computer device/merchandise manufacturers, distributors, retailers, etc., via an Internet connection, phone line, radio frequency link, etc. The computer device and advertisement information may be any combination of: manufacturer specification advertisement, operation system specification advertisement, micro processer speed specification advertisement, memory size specification advertisement, memory type specification advertisement, dimension specification advertisement, weight specification advertisement, color specification advertisement, style specification advertisement, wireless subscription plan specification advertisement, computer network connection speed specification advertisement, computer network connection type specification advertisement, display technology specification advertisement, display size specification advertisement, display resolution specification advertisement, software revision specification advertisement, connection coverage availability specification advertisement, connection technology specification advertisement, battery type specification advertisement, camera resolution quality specification advertisement, ability to customize specification advertisement, keyboard type specification advertisement, GPS availability specification advertisement, etc.

The computer ID and specification information is correlated with advertisement object information received from the computer device/merchant/advertisement manufacturers, distributors, retailers, etc., by the server 10. Server 10 may perform the correlation using local memory or may store the information (step 1802) in data structures, such as tables, in database 14.

At step 1803, server 10 queries the user's associated computer embedded object to receive information such as an ID code for the user's associated computer embedded object or a specification of the user's associated computer embedded object from the user's computer.

At step 1804, the server 10 compares the user associated computer's specification with the specification of the advertisement merchandise. In an example embodiment, the server 10 selects the advertisement having merchandise with a better specification than the specification of the user associated computer embedded object.

At step 1805, the server 10 calculates the percentage of improvement from the specification of the advertisement merchandise vs. the specification of the user's associated computer embedded object. For example, the server 10 lists all of the advertisement merchandise computers that have a 10% faster microprocessor speed than the user's associated computer embedded object.

At step 1806, the server 10 sorts the list with the target specifications, possibly by the speed of the microprocessor or the percentage of improvement of the specification over the user's associated computer embedded object.

At step 1807, an optional step, the server 10 selects advertisements from the sorted list.

At step 1808, server 10 sends the sorted list of advertisements to the user's computer.

For example, server 10 queries the database for the ID or specification of the user's associated computer embedded object and sends the correlated comparison specification advertisement to the user's computer. The server 10 may follow the process flow as described in FIG. 18, or by other process flows, such as, where the server 10 sends the corresponding advertisement, after the server 10 acquires the user associated computer's ID or specification. For example, the server 10, may compare, calculate the percentage of the improvement, and/or sort all of the specifications of the advertisement merchandise provided by the information provider. This comparison specification of the advertisements may be stored in a database. The correlated advertisements may be sent to the user computer's display device by the user's computer.

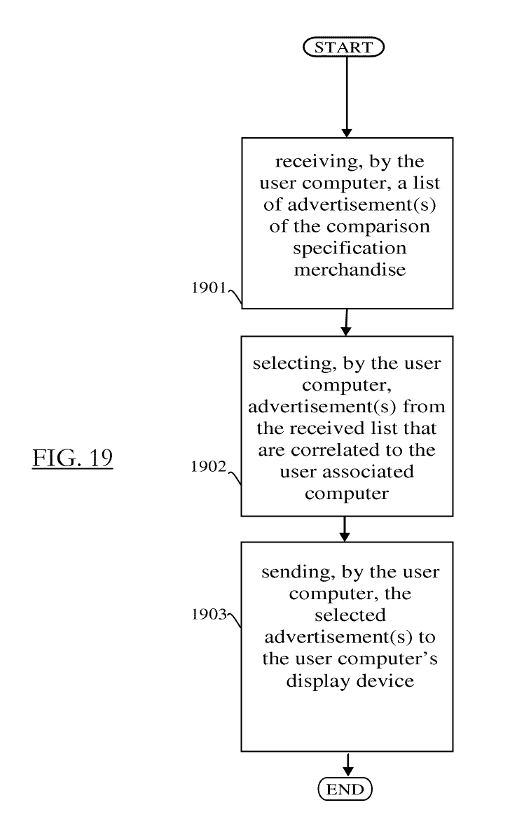

Referring to FIG. 19, the server 10 sends a list of advertisement(s) of comparison specifications to the user computer. The server 10, compares, calculates, and sorts all the specifications of the advertisement merchandise provided by the information provider and stores the comparison specifications of the advertisement merchandise in a database. The user's computer 30 selects a corresponding advertisement which is correlated to the user associated computer embedded object ID or specification. The selected advertisement may be sent to the user computer's display device by the user's computer.

At step 1901, the user's computer receives a list of the advertisement(s) of the comparison specifications of the merchandise.

At step 1902, the user's computer selects the advertisement(s) from the received list of the advertisements that correspond to the user's associated computer embedded object specification or ID.

At step 1903, the user computer sends the selected advertisement(s) to the display device of the user's computer.

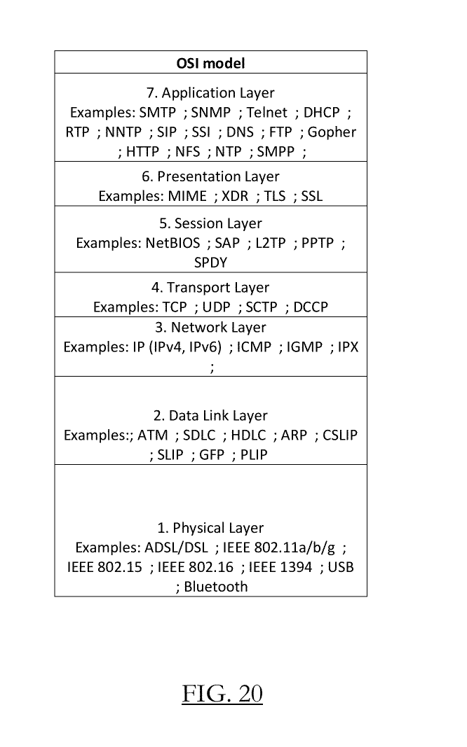

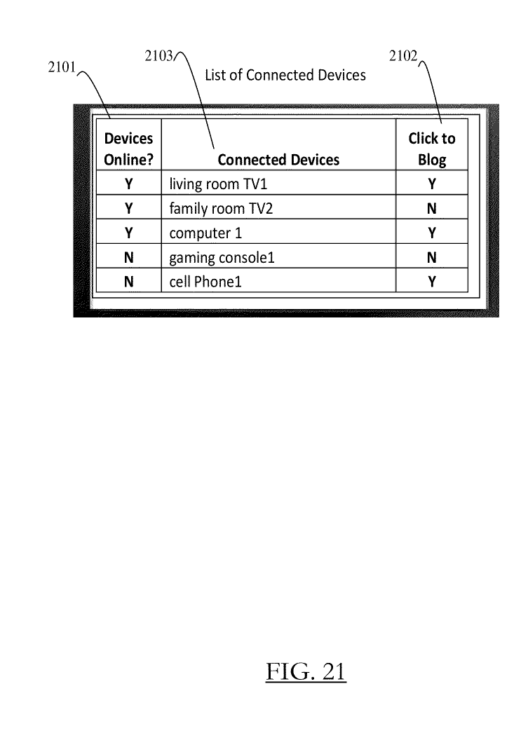

Referring to FIG. 20, the associated computer embedded object sends the identification code of the associated computer embedded object to the server 10 or to the user computer through a computer network connection that complies with the OSI model. The OSI model is a way of sub-dividing a communication system into smaller parts called layers. Similar communication functions are grouped into logical layers. The identification code, specification or configuration of the associated computer embedded object may be transferred through one, if not all, of the following layers—Physical Layer, Data Link Layer, Network Layer, Transport Layer, Session Layer, Presentation Layer, and Application Layer—as described in the Open System Interconnection Model. The data, including for example the identification code, specification, or configuration of the associated computer embedded object, is encapsulated and sent from the associated computer embedded object to the user or server. The user or server receives and de-encapsulates the data. The search criteria derives from the data, include the identification code, specification, or configuration of the associated computer embedded object.

Referring to FIG. 21, an example of the user interface of a program that displays on the user's computer shows a list of the associated computer embedded objects, the list including for example the hostname of a computer that the user is interested in. Box 2101 indicates if the corresponding associated computer embedded object is computer network connected or not. The box 2102 indicates if the selected associated computer embedded object is available for blogging by the user, and if so, the user may optionally turn on the blog function. As shown in the example of FIG. 21, the list of the associated computer embedded objects includes living room TV1, family room TV1, computer 1, gaming console 1,and cell phone 1.

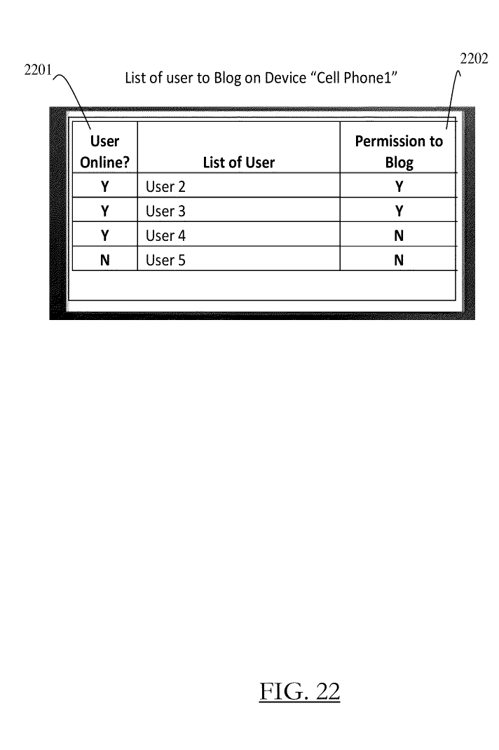

FIG. 22 shows an example in which several users are communicating with each other. Each user may optionally have different assigned access and communication permissions. For example: user 2 and user 3 have the permission to blog about cell phone1, while user 4 and user 5 do not have the permission to blog about cell phone1. This may be useful when, for example, one user wishes to assign limited access permission to another user.

Referring to FIG. 22, an example of the user interface of a program that displays on the user's computer shows “cell phone1” blog permission for a list of the users, with user id, where “cell phone1” is an example of the hostname of a list of the associated computer embedded object that the user is interested in. Box 2201 indicates if another authorized user is computer network connected or not. For example, a user may login into a social network website, instant message website, or blog website to real time two way communicate with another user about the “cell phone1”. In box 2202, a user may turn on or off the blog permission of another user.

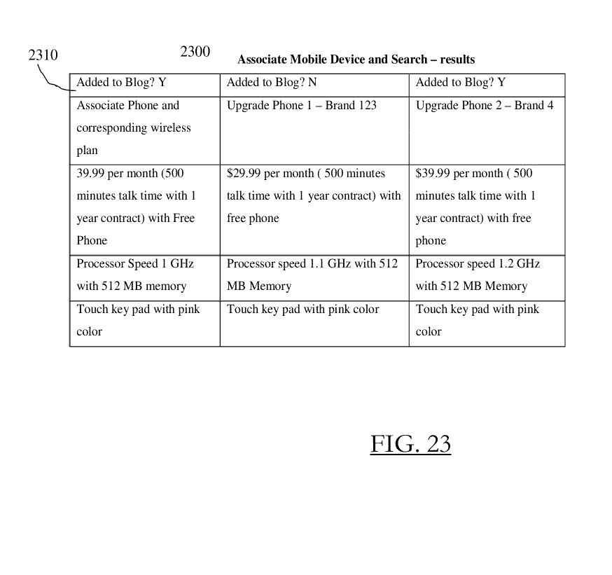

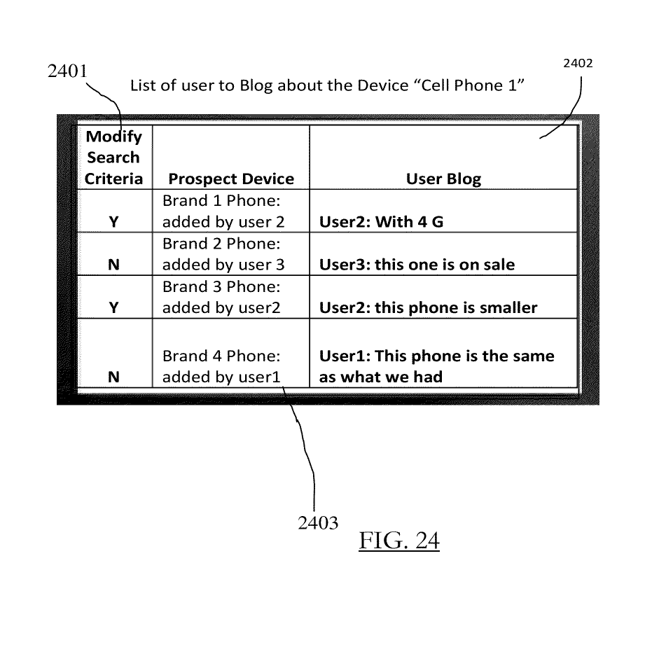

Referring to FIG. 23, an example of the user interface of a program that displays on the user's computer shows an example of a list of the computer search results corresponding to an upgrade request of an associated computer embedded object. The user may optionally add the search results to the blog. The user may further optionally add comments to the blog. The blog has a topic, the topic determines the search criteria along with identification code, specification or configuration of the associated computer embedded object, and search results may be added back into the blogs. The topic of the blog is information about the associated computer embedded object. The topic may be identified with a pre-assigned symbol prefix. For example, “#cellaccessories” identifies a topic of cell phone accessories for a search. The search results may include accessories for the associated computer embedded object. Referring to FIG. 24, the user interface of a program that displays on the user's computer shows search results, from a search criteria derived from an identification code of an associated computer embedded object, for a possible upgrade or replacement of the associated computer embedded object. The comments or blog may be displayed by a table format that is associated to the associated computer embedded object, in this case it may optionally include the blogs or comments on “Cell Phone1”. The comments or blogs of a user may optionally be as indicated in box 2402. Box 2401, is to set the search criteria for a similar specification to the corresponding search results. Each user may add their own comments to the blog, as shown. Each user may add one or more suggested devices, as a suggestion to replace the “Cell Phone1”. Each of these suggested devices may be added from the search results of each individual search over the internet. The specification of the suggested computer embedded object will be used to re-construct the user's search criteria when the user click “Y” as shown in the Box “2401”. One of the example methods to implement this feature is to search the database within a selected percentage, for example +/−5%, of the specification of the suggested device. The search result will be delivered back to the user.

FIG. 25 illustrates an example of the user interface of an application program that displays on the user's computer, such as a smart phone. The application program may have one of the following functions: storing user id and password of a plurality of associated computer embedded object, and establishing a computer network communication link between the user computer and an associated computer embedded object to retrieve the identification code of each of the associated computer embedded object. In box 2501, the user interface of the application software has the user id “phone4userid” and password “phone4userpassword” stored. In box 2502, a “Y” is displayed on the phone 4 column, indicating the application software is showing the user has the permission to access of identification code, IMEI, specification, or configuration of the phone 4 if the user logs into the phone 4 using the phone 4 IP address, phone4userid, and phone4userpassword.

Referring to FIG. 26, FIG. 26 illustrates an example of computer embedded object database in a tabular form. The database may include a list of computer embedded objects with identification code, specification, or configuration. For example, the database may include hostname, model name, and IMEI for each of the computer embedded object, as shown in the FIG. 26. This database may be manually added or input by the user. Or it may be derived from the finance database, e.g., purchasing history.

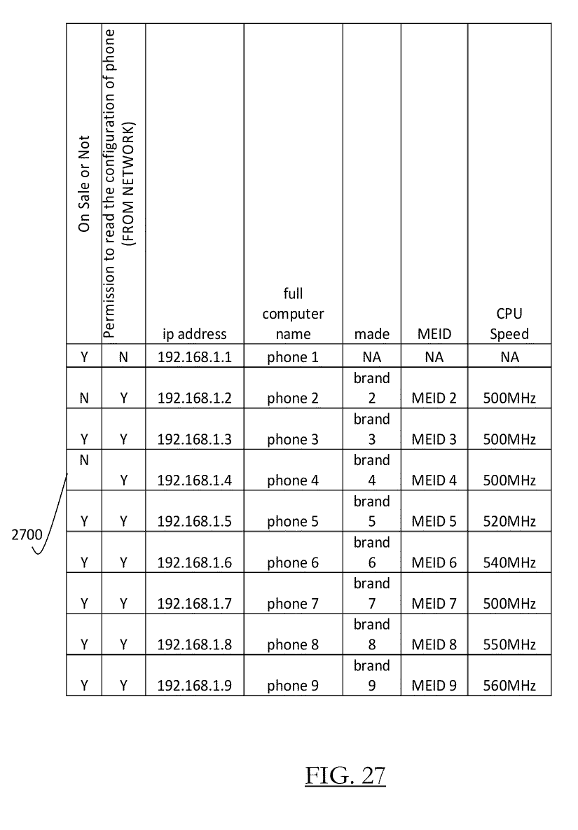

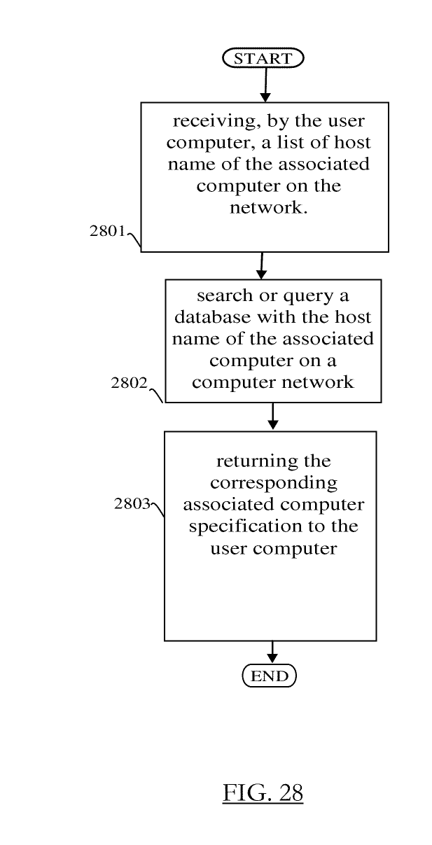

Referring to FIG. 27, FIG. 27 illustrates an example of a combination list of the computer embedded objects database in a tabular form. The combination list of the computer embedded objects include, but not limited to, a first list of computer embedded objects from a shopping database and a second list of the computer embedded objects, which is the list of the user's associated computer embedded objects. The combination list of the computer embedded objects database may include an identification code, specification, or configuration for each of the computer embedded objects in the list. For example an application software, installed and executed in the user computer, may combine the first list of computer embedded objects from a shopping database and the second list of the computer embedded objects, which may include a portion of specification of the list of the user's associated computer embedded objects from a database. The application software may populate a portion of specification of the associated computer embedded object into the database, as shown in the example of FIG. 27. The first list of the computer embedded objects and specifications might be further derived from a search of a database, where the search criteria may be derived from the hostname of the user's associated computer embedded object. The second list of the associated computer embedded object may receive data from a database having a more complete description of the computer embedded object, for example database 14. User may be able to retrieve the full specification of the user's associated computer embedded object in order to shop or upgrade the replacement of the associated computer embedded object.

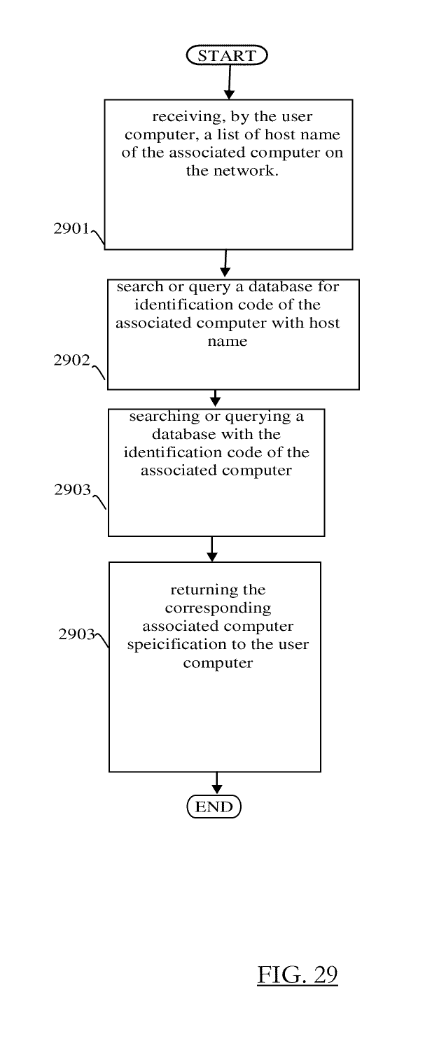

FIG. 28 illustrates an example of process flow of the user computer to search a database to retrieve the specification of an associated computer embedded object by using the host name of the user computer; wherein the user computer retrieved the host name of the user computer through a computer network. In this case, the user may compare the specification of the associated computer embedded object to the specification of the possible replacement of the associated computer embedded object.

FIG. 29 illustrates an example of a process flow of the user computer to search a database to retrieve the specification of an associated computer embedded object by using the identification code of the user's associated computer embedded object; wherein the user computer to retrieve the host name of the user's associated computer embedded object, and to retrieve the identification of the associated computer embedded object by the hostname of the associated computer embedded object through a computer network. In this case, the user may compare the specification of the associated computer embedded object to the specification of the possible associated computer embedded object replacement.

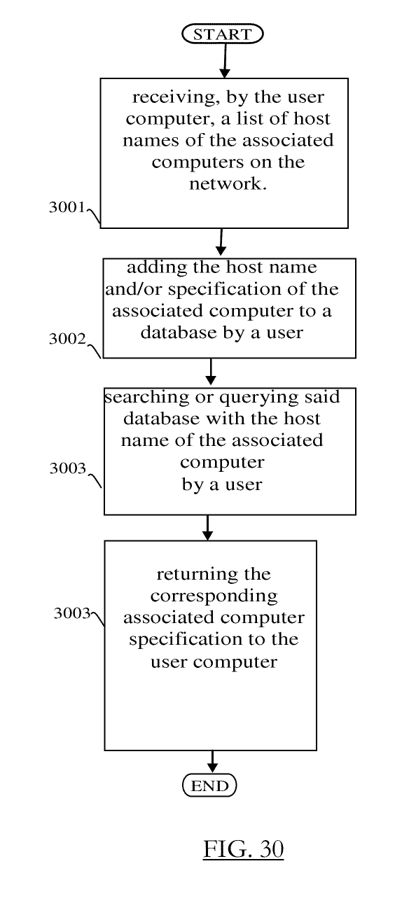

FIG. 30 illustrates an example of a process flow to build a database of the identification codes and corresponding host names of the associated computer embedded object. This process builds such a database by accessing a list of hostnames of the associated computer embedded objects on a computer network by the user computer. For example, the program may be an application program of a smart phone and may collect a list of the computer hostname from a computer network. The program may interact with a user for the user to input specification or identification code or model name of the corresponding computer, respective to the hostname. The application software, on the smart phone, may have the user interface such as the FIG. 4, for user to search for the accessories of the associated computer embedded objects. Data entry area 413 might contain a list of the hostname of associated computer embedded object for the user to choose from. The application software may reside on any computer embedded object, such as smart phone, ebook, mobile computing device. The application software may be able to collect all or partial hostname of the user computers that the user computer embedded objects have previously connected to. The user interface of such software, may be able to interact with a user for input model number or identification code of the corresponding computer. Such software may execution the server and display on the user's display device. The database, the user is building, may be located in a local user computer, or it might be in cloud or in a database associated to a server computer.

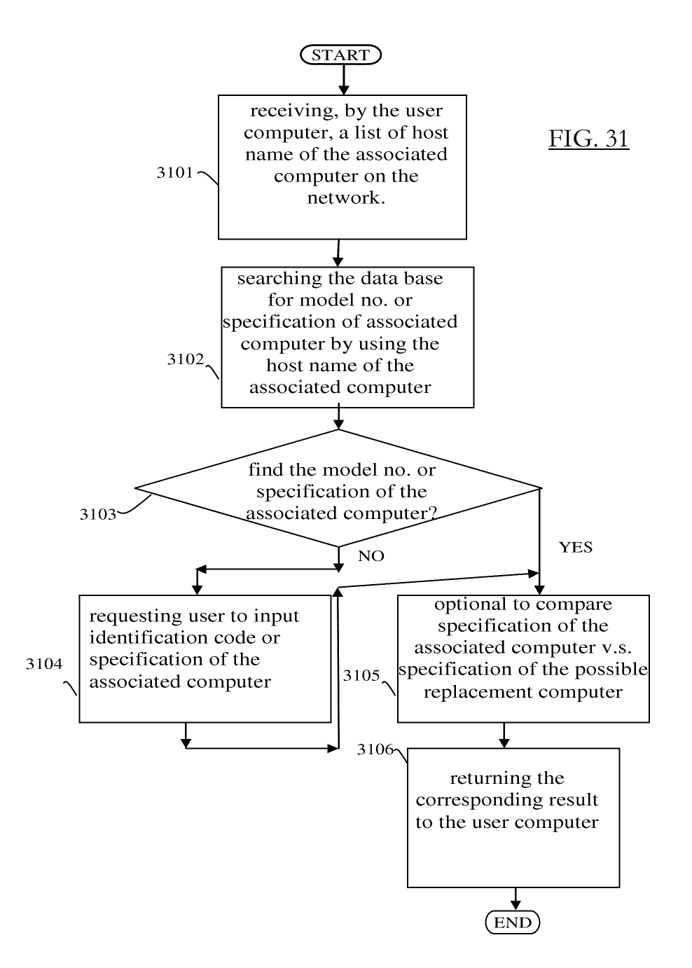

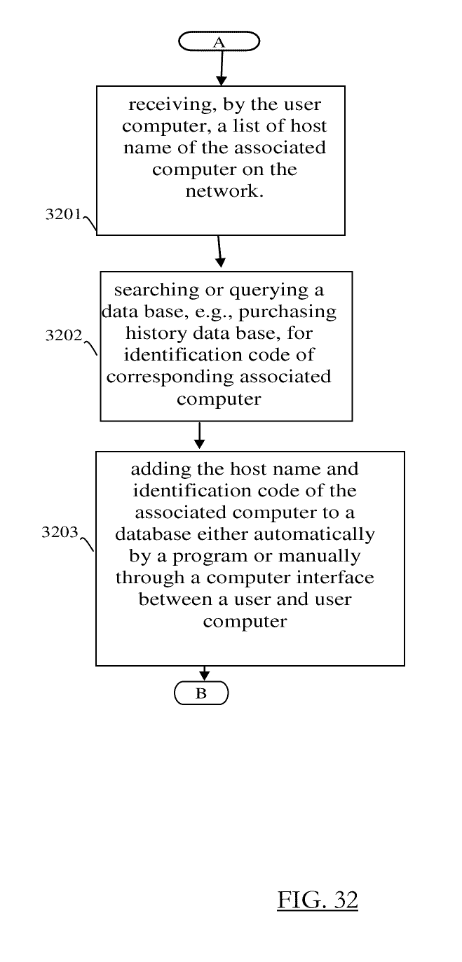

FIG. 31 illustrates an example of a process flow of a computer program to search for a replacement of a network computer or accessories of a network computer by accessing the host name of the network computer from a user computer with a possible user interface for a user to input the specification or identification code of the network computer. The process flow may include a decision making process flow, as indicating in FIG. 30. The decision making process flow may switch based on a decision condition e.g., “can application software find the model no. or specification of the associated computer embedded object?”. The process flow of the application software may execute between a user interface for user to manually input and program instruction to automatically insert the identification code or specification of the associated computer embedded object according to the hostname of the associated computer embedded object on the computer network into a database. User may be able to retrieve the full specification of the user's associated computer embedded object in order to shop or upgrade the replacement of the associated computer embedded object, according to the FIG. 31. In an example embodiment, a step of the user or application software may insert the identification code, derived from to a host name, of an associated computer embedded object to a database, such a database will be used to retrieve a more complete specification of the associated computer embedded object.

FIG. 32 illustrates an example of a process flow a of a computer program to build a database of the hostname of a computer embedded object to the identification code or specification of the corresponding computer embedded object through a computer network. This process may be for a user to manually input, or for a computer automatically enters, the identification code or specification of a computer embedded object corresponding to the hostname of a computer on the computer network. adding identification code, corresponding to a host name, of an associated computer on a computer network to a database. The identification code of an associated computer may be used to retrieve specification of the associated computer embedded object.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, computer networking devices or any other device that incorporates hard-wired and/or program logic to implement the techniques.

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media may also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer may load the instructions into its dynamic memory and send the instructions over a telephone line using a modem. A modem local to computer system 1000 may receive the data on the telephone line and use an infra-red transmitter to convert the data to an infra-red signal. An infra-red detector may receive the data carried in the infra-red signal and appropriate circuitry may place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a computer network link 1020 that is connected to a local computer network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Computer network link 1020 typically provides data communication through one or more computer networks to other data devices. For example, computer network link 1020 may provide a connection through local computer network 1022 to a host computer 1024 or to data equipment operated by an Internet Service Provider (ISP) 1026. ISP 1026 in turn provides data communication services through the world wide packet data communication network now commonly referred to as the “Internet” 1028. Local computer network 1022 and Internet 1028 both use electrical, electromagnetic or optical signals that carry digital data streams. The signals through the various computer networks and the signals on computer network link 1020 and through communication interface 1018, which carry the digital data to and from computer system 1000, are example forms of transmission media.

Computer system 1000 may send messages and receive data, including program code, through the computer network(s), computer network link 1020 and communication interface 1018. In the Internet example, a server 1030 might transmit a requested code for an application program through Internet 1028, ISP 1026, local computer network 1022 and communication interface 1018.

The received code may be executed by processor 1004 as it is received, and/or stored in storage device 1010, or other non-volatile storage for later execution.

### 9. Example Embodiments

In an example embodiment, a method comprises or a computer-readable medium carrying one or more sequences of instructions, which instructions, when executed by one or more processors, cause the one or more processors to carry out the steps of: receiving, at a server, information from an information provider;storing the received information in a database on a nontransitory storage medium, the received information including an identifier of at least one merchandise and description of the at least one merchandise; receiving, by the server, a search criteria from a user computer, the search criteria including an identification code of a computer embedded object, wherein the identification code is derived from a hostname of the computer embedded objects; processing, by the server, the identification code to obtain a specification of the computer embedded object; searching the database, by the server, for information that matches a description of merchandise of interest, the description of merchandise of interest derived from the specification of the computer embedded object; and sending results from the search to the user computer.

Optionally, in an example embodiment, a method or computer-readable medium further comprises wherein the computer embedded object may be any of: a mobile device, a personal computer, a smart phone, a workstation computer, an ebook computer, a vehicle, a TV, or a mobile gaming device.

Optionally, in an example embodiment, a method or computer-readable medium further comprises wherein the identification code of the computer embedded object may be any of: string of codes, Internet Protocol address, Media Access Control address, host name, International Mobile Subscriber Identity, Temporary Mobile Subscriber Identity, International Mobile Equipment Identity, Mobile Equipment Identifier, Type Allocation Code, string of ASCII characters, serial number, FCC ID, and model number.

Optionally, in an example embodiment, a method or computer-readable medium further comprises wherein the description of merchandise includes the specification of merchandise, wherein the specification of merchandise may be any of: manufacturer specification, operation system specification, microprocesser speed specification, memory size specification, memory type specification, dimension specification, weight specification, color specification, style specification, wireless subscription plan specification, computer network connection speed specification, computer network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

Optionally, in an example embodiment, a method or computer-readable medium further comprises wherein the specification of the computer embedded object may be any of: manufacturer specification, operating system specification, microprocessor speed specification, memory size specification, memory type specification, dimension specification, weight specification, color specification, style specification, wireless subscription plan specification, computer network connection speed specification, computer network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

Optionally, in an example embodiment, a method or computer-readable medium further comprises wherein the search results include a specification of a computing device.

Optionally, in an example embodiment, a method or computer-readable medium further comprises wherein the search results include a pictorial depiction of the computer embedded object and a computer embedded device.

Optionally, in an example embodiment, a method or computer-readable medium further comprises wherein the server charges an advertiser a fee for sending an advertisement to the user computer.

Optionally, in an example embodiment, a method or computer-readable medium further comprises wherein the search results include a price of a computing device.

Optionally, in an example embodiment, a method or computer-readable medium further comprises wherein a user initiates sending the search criteria from the user computer to the server.

Optionally, in an example embodiment, a method or computer-readable medium further comprises receiving a user's selection of one or more merchandise from the search results; adding the one or more selected merchandise to an electronic shopping checkout system.

Optionally, in an example embodiment, a method or computer-readable medium further comprises wherein the one or more merchandise may be selected from the following group: a computing device and a mobile device accessory.

Optionally, in an example embodiment, a method or computer-readable medium further comprises wherein the computing device may be a mobile device.

Optionally, in an example embodiment, a method or computer-readable medium further comprises wherein the mobile device may be a cellular phone device or an ebook.

Optionally, in an example embodiment, a method or computer-readable medium further comprises wherein the mobile device accessory may be selected from the following group of: a headset, case, pouch, or mobile device charger.

Optionally, in an example embodiment, a method or computer-readable medium further comprises

Optionally, in an example embodiment, a method or computer-readable medium further comprises including, in the search results, a price and availability of merchandise in the search results; accepting user input selection of a quantity of each of the merchandise for purchasing; transferring the selected quantity of each of the selected merchandise to a computer network shopping basket; accepting user input to purchase the selected quantity of each of the selected merchandise; notifying the user of the completion of the purchase.

In an example embodiment, a method comprises or a computer-readable medium carrying one or more sequences of instructions, which instructions, when executed by one or more processors, cause the one or more processors to carry out the steps of: in response to receiving input from a user at a user computer, retrieving a hostname of a computer embedded object that the user computer may be associated with; sending, by the user computer, search criteria to a server, the search criteria including at least the identification code of a computer embedded object, wherein the identification code derived from the hostname of the computer embedded objects; receiving, by the user computer, search results from the server, the search results including a description of merchandise of interest derived from the identification code of the computer embedded object; displaying, by the user computer, the search results to a user on a display communicatively connected to the user computer.

Optionally, in an example embodiment, a method or computer-readable medium further comprises wherein the search results include a specification of a computing device or a replacement object.

Optionally, in an example embodiment, a method or computer-readable medium further comprises wherein the search results include a comparison specification of one or more computing devices or one or more replacement objects.

Optionally, in an example embodiment, a method or computer-readable medium further comprises wherein selection of the one or more computing devices or the one or more replacement objects in the comparison specification may be based on a percentage of improvement over the computer embedded object.

Optionally, in an example embodiment, a method or computer-readable medium further comprises wherein the search results include comparison advertisements for one or more computing devices or for one or more replacement objects.

Optionally, in an example embodiment, a method or computer-readable medium further comprises wherein selection of the one or more computing devices or the one or more replacement objects in the comparison advertisements may be based on a percentage of improvement over the computer embedded object.

Optionally, in an example embodiment, a method or computer-readable medium further comprises wherein the search results include a pictorial depiction of the computer embedded object and a replacement object.

Optionally, in an example embodiment, a method or computer-readable medium further comprises wherein the search results include a price of a computing device or a replacement object.

Optionally, in an example embodiment, a method or computer-readable medium further comprises reporting, by the user computer, to the server, any advertisements in the search results that the user views or selects.

Optionally, in an example embodiment, a method or computer-readable medium further comprises reporting, by the user computer, to the server, any links in the search results that the user views or selects.

Optionally, in an example embodiment, a method or computer-readable medium further comprises wherein the identification code derived from the hostname of the computer embedded object and an identity authenticating password, and wherein the identity authenticating password and the hostname of the computer embedded object may be used for accessing the identification code stored in computer embedded object.

Optionally, in an example embodiment, a method or computer-readable medium further comprises storing, by the server, at least partial of the search criteria in a database, wherein the partial stored search criteria including at least one hostname and one corresponding identification code of a computer embedded object.

Optionally, in an example embodiment, a method or computer-readable medium further comprises wherein the at least one hostname and one corresponding identification code of a computer embedded object manually input by the user through a computer user interface.

Optionally, in an example embodiment, a method or computer-readable medium further comprises wherein the at least one hostname and one identification code of a computer embedded object partially derived from a user purchasing history database.

Optionally, in an example embodiment, a method or computer-readable medium further comprises receiving, at a server, at least one comment related to the computer embedded object from a user computer; storing, by the server, the comment in a database.

Optionally, in an example embodiment, a method or computer-readable medium further comprises wherein the user computer may be the first user computer and, further comprising: receiving, at a server, at least one comment related to the computer embedded object from a second user computer; storing, by the server, the comment from the second user computer in a database.

Optionally, in an example embodiment, a method or computer-readable medium further comprises receiving, at a server, an updated search criteria, wherein the updated search criteria derived from the search results.

Optionally, in an example embodiment, a method or computer-readable medium further comprises wherein the search results includes specification of the merchandise of interest.

In an example embodiment, a method comprises or a computer-readable medium carrying one or more sequences of instructions, which instructions, when executed by one or more processors, cause the one or more processors to carry out the steps of: in response to receiving input from a user at a user computer, sending search criteria to a server, the search criteria including search terms for objects that the user may be interested in; receiving, by the user computer, search results from the server, the search results including a description of merchandise of interest; retrieving, by the user computer, an identification code of a computer embedded object, wherein the identification code derived from hostname of the computer embedded object; filtering the search results using the identification code of the computer embedded object; displaying, by the user computer, the filtered search results to a user on a display communicatively connected to the user computer.

Optionally, in an example embodiment, a method or computer-readable medium further comprises wherein the search results include a specification of a computing device or a replacement object.

Optionally, in an example embodiment, a method or computer-readable medium further comprises wherein the search results include a comparison specification of one or more computing devices or one or more replacement objects.

Optionally, in an example embodiment, a method or computer-readable medium further comprises wherein selection of the one or more computing devices or the one or more replacement objects in the comparison specification may be based on a percentage of improvement over the computer embedded object.

Optionally, in an example embodiment, a method or computer-readable medium further comprises wherein the search results include comparison advertisements for one or more computing devices or for one or more replacement objects.

Optionally, in an example embodiment, a method or computer-readable medium further comprises wherein selection of the one or more computing devices or the one or more replacement objects in the comparison advertisements may be based on a percentage of improvement over the computer embedded object.

Optionally, in an example embodiment, a method or computer-readable medium further comprises wherein the search results include a pictorial depiction of the computer embedded object and a replacement object.

Optionally, in an example embodiment, a method or computer-readable medium further comprises wherein the search results include a price of a computing device or a replacement object.

Optionally, in an example embodiment, a method or computer-readable medium further comprises reporting, by the user computer, to the server, any advertisements in the search results that the user views or selects.

Optionally, in an example embodiment, a method or computer-readable medium further comprises reporting, by the user computer, to the server, any links in the search results that the user views or selects.

Optionally, in an example embodiment, a method or computer-readable medium further comprises wherein the identification code derived from the hostname of the computer embedded object and an identity authenticating password, and wherein the identity authenticating password and the hostname of the computer embedded object may be used for accessing the identification code stored in computer embedded object.

Optionally, in an example embodiment, a method or computer-readable medium further comprises storing, at a user computer, at least partial of the search criteria in a database, wherein the partial stored searched criteria including at least one hostname and one corresponding identification code of a computer embedded object.

Optionally, in an example embodiment, a method or computer-readable medium further comprises wherein the at least one hostname and one corresponding identification code of a computer embedded object manually input by the user through a computer user interface.

Optionally, in an example embodiment, a method or computer-readable medium further comprises wherein the at least one hostname and one identification code of a computer embedded object partially derived from a user purchasing history database.

Optionally, in an example embodiment, a method or computer-readable medium further comprises receiving, at a user computer, at least one comment related to the computer embedded object from a user computer; storing, by the user computer, the comment in a database.

Optionally, in an example embodiment, a method or computer-readable medium further comprises wherein the user computer may be the first user computer and, further comprising: receiving, at a user computer, at least one comment related to the computer embedded object from a second user computer; storing, by the user computer, the comment from the second user computer in a database.

Optionally, in an example embodiment, a method or computer-readable medium further comprises receiving, at a user computer, an updated search criteria, wherein the updated search criteria derived from the search results.

Optionally, in an example embodiment, a method or computer-readable medium further comprises wherein the search results includes specification of the merchandise of interest.

Optionally, in an example embodiment, a method or computer-readable medium further comprises storing, by the user computer, at least partial of the search criteria in a database, wherein the partial stored search criteria including at least one hostname and one corresponding identification code of a computer embedded object.

Optionally, in an example embodiment, a method or computer-readable medium further comprises wherein the at least one hostname and one corresponding identification code of a computer embedded object manually input by the user through a computer user interface.

Optionally, in an example embodiment, a method or computer-readable medium further comprises wherein the at least one hostname and one identification code of a computer embedded object partially derived from a user purchasing history database.

Optionally, in an example embodiment, a method or computer-readable medium further comprises receiving, by the user computer, at least one comment related to the computer embedded object from a user computer; storing, by the user computer, the comment in a database.

Optionally, in an example embodiment, a method or computer-readable medium further comprises receiving, by a second user computer, at least one comment related to the computer embedded object from a second user computer; storing, by the second user computer, the comment from the second user computer in a database.

Optionally, in an example embodiment, a method or computer-readable medium further comprises receiving, by the user computer, an updated search criteria, wherein the updated search criteria derived from the search results.

Optionally, in an example embodiment, a method or computer-readable medium further comprises wherein the search results includes specification of the merchandise of interest.

In an example embodiment, a method comprises or a computer-readable medium carrying one or more sequences of instructions, which instructions, when executed by one or more processors, cause the one or more processors to carry out the steps of sharing identification information between a plurality of users participating in a social networking service, each of the plurality of users having a computer embedded object, the method executed by a computer system, the method or the computer-readable medium comprising: receiving information relating to a computer embedded object of a first user of the plurality of users; and sending the information of the computer embedded object to a second user for display.

Optionally, in an example embodiment, a method or computer-readable medium further comprises wherein the information comprises an identification code.

Optionally, in an example embodiment, a method or computer-readable medium further comprises wherein the identification code may be stored in the computer embedded object.

Optionally, in an example embodiment, a method or computer-readable medium further comprises wherein the identification code stored in a memory of the computer embedded object.

Optionally, in an example embodiment, a method or computer-readable medium further comprises associating the identification code with a specification of the computer embedded object.

Optionally, in an example embodiment, a method or computer-readable medium further comprises wherein the information comprise the comment information relating to the computer embedded object of a first user of the plurality of users.

Optionally, in an example embodiment, a method or computer-readable medium further comprises wherein the comment information comprises information about the usage experience of the first user.

Optionally, in an example embodiment, a method or computer-readable medium further comprises wherein the comment information comprises a log file of the computer embedded object.

Optionally, in an example embodiment, a method or computer-readable medium further comprises wherein the comment information may be a tweet.

Optionally, in an example embodiment, a method or computer-readable medium further comprises wherein the comment information may be located in a fan page.

Optionally, in an example embodiment, a method or computer-readable medium further comprises wherein the social networking service may be any of: Facebook, twitter, and Google plus.

Optionally, in an example embodiment, a method or computer-readable medium further comprises wherein the identification code may be derived from a hostname of the computer embedded object and an identity authenticating password.

Optionally, in an example embodiment, a method or computer-readable medium further comprises wherein the identification code may be delivered through a computer network.

In an example embodiment, a method comprises or a computer-readable medium carrying one or more sequences of instructions, which instructions, when executed by one or more processors, cause the one or more processors to carry out the steps of sharing identification information between a plurality of users participating in a social networking service, each of the plurality of users having a computer embedded object, the method executed by a computer system, the method or the computer-readable medium comprising: receiving information of group computer embedded objects from a group of users; selecting consumer information from a database according to the received information; sending the selected consumer information to the group of users for display.

Optionally, in an example embodiment, a method or computer-readable medium further comprises wherein the received information comprises any of or any combination of a list of identification codes, specifications, and carrier service plans.

Optionally, in an example embodiment, a method or computer-readable medium further comprises wherein the consumer information comprises any of or any combination of promotion and advertisement information.

Optionally, in an example embodiment, a method or computer-readable medium further comprises wherein the consumer information comprises any of or any coupons, sales information and promotion materials.

Optionally, in an example embodiment, a method or computer-readable medium further comprises wherein the specifications includes the communication data rates of each of the group of computer embedded objects; wherein the communication data rates are utilized such that each of the embedded objects receive appropriate consumer information.

Optionally, in an example embodiment, a method or computer-readable medium further comprises wherein each of the group of computer embedded objects includes a device type associated therewith; wherein each of the embedded objects receive appropriate consumer information based upon the device type.

Optionally, in an example embodiment, a method or computer-readable medium further comprises wherein the identification code may be derived from a hostname of the computer embedded object and an identity authenticating password.

Optionally, in an example embodiment, a method or computer-readable medium further comprises wherein the selected consumer information may be any of the selection or indication of the webpage setup by the users.

In an example embodiment, a method comprises or a computer-readable medium carrying one or more sequences of instructions, which instructions, when executed by one or more processors, cause the one or more processors to carry out the steps of collecting data of a plurality of users participating in a social networking service, each of the plurality of users having a computer embedded object connected to a computer network, the method executed by a computer system, the method comprising: providing a server to access the data; and building a database accessed by the server; wherein the data may be provided to the server from at least one of the computer embedded objects to build the database and wherein the data including a identification code of the at least one of the computer embedded object.

Optionally, in an example embodiment, a method or computer-readable medium further comprises wherein the identification code of the at least one of the computer embedded object stored in the memory of the computer embedded object.

Optionally, in an example embodiment, a method or computer-readable medium further comprises steps of utilizing data mining techniques on the built database.

Optionally, in an example embodiment, a method or computer-readable medium further comprises steps of utilizing data management techniques on the built database.

Optionally, in an example embodiment, a method or computer-readable medium further comprises wherein each of the computer embedded object include an identification code.

Optionally, in an example embodiment, a method or computer-readable medium further comprises wherein the identification code may be stored in a memory of its associated computer embedded object embedded object.

Optionally, in an example embodiment, a method or computer-readable medium further comprises associating the identification code with a specification of its computer embedded object.

Optionally, in an example embodiment, a method or computer-readable medium further comprises wherein each of the specifications includes the data rates of each of the group of computer embedded objects; and wherein the data rates are utilized such that each of the embedded objects receive appropriate consumer information.

Optionally, in an example embodiment, a method or computer-readable medium further comprises wherein each of the computer embedded objects includes a device type associated therewith; wherein each of the embedded objects receive appropriate consumer information based upon the device type.

Optionally, in an example embodiment, a method or computer-readable medium further comprises wherein information between the computer embedded object and statistics of the computer embedded object are correlated with the usage of the computer embedded object.

Optionally, in an example embodiment, a method or computer-readable medium further comprises wherein the information of the computer embedded object may be the model number of a portable device and the statistics are the viewing statistics of a text message of users that have the model number of the portable device, wherein the viewing statistics and the model number are correlated length of time the users are using the portable device.

Optionally, in an example embodiment, a method or computer-readable medium further comprises wherein information between the computer embedded object and at least one parameter of the database are correlated to provide information to the provider.

In an example embodiment, a method comprises or a computer-readable medium carrying one or more sequences of instructions, which instructions, when executed by one or more processors, cause the one or more processors to carry out the steps of: receiving, at a server, a merchandise of interest and a first list comprising an identification code of a computer embedded object from a computing device; combining, by the server, a second list comprising at least one identification code of a computer embedded object with at least a portion of the first list to create a third list; processing, by the server, an identification code from the third list to obtain a description from a database that matches the identification code; sending information, from the server, to the computing device wherein the sent information is related to the merchandise of interest, the sent information derived from the description obtained from the database.

In an example embodiment, a method comprises or a computer-readable medium carrying one or more sequences of instructions, which instructions, when executed by one or more processors, cause the one or more processors to carry out the steps of: in response to receiving input from a user at a user computer, retrieving a first list comprising an identification code of a computer embedded object; combining, by the user computer, a second list comprising at least one identification code of a computer embedded object with at least a portion of the first list to create a third list; sending, by the user computer, to a server a merchandise of interest and the third list; receiving, by the user computer, information related to the merchandise of interests from the server, wherein the received information derived from the third list.

In an embodiment, an apparatus comprises subsystems, implemented at least partially in hardware for: a device, at a server, that receives information from an information provider; a device that stores the received information in a database, the received information including an identifier of at least one merchandise and description of the at least one merchandise; a device, at a server, that receives a search criteria from a user computer of a plurality of user computers, the search criteria including at least an identification code of a computer embedded object, wherein the identification code derived from hostname of the computer embedded objects; a device, at a server, that processes the identification code to obtain a specification of the computer embedded object; a device, at a server, that searches the database for information that matches a description of merchandise of interest, the description of merchandise of interest derived from the specification of the computer embedded object; a device, at a server, that sends results from the search to the user computer.

In an embodiment, an apparatus further comprises wherein the computer embedded object may be any of: a mobile device, a personal computer, a workstation computer, an ebook computer, a vehicle, a TV, and a mobile gaming device.

In an embodiment, an apparatus further comprises wherein the identification code of the computer embedded object may be any of: string of codes, Internet Protocol address, Media Access Control address, host name, International Mobile Subscriber Identity, Temporary Mobile Subscriber Identity, International Mobile Equipment Identity, Mobile Equipment Identifier, Type Allocation Code, string of ASCII characters, serial number, FCC ID, and model number.

In an embodiment, an apparatus further comprises wherein the description of merchandise includes the specification of merchandise, wherein the specification of merchandise may be any of: manufacturer specification, operation system specification, microprocesser speed specification, memory size specification, memory type specification, dimension specification, weight specification, color specification, style specification, wireless subscription plan specification, computer network connection speed specification, computer network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

In an embodiment, an apparatus further comprises wherein the specification of the computer embedded object may be any of: manufacturer specification, operating system specification, microprocesser speed specification, memory size specification, memory type specification, dimension specification, weight specification, color specification, style specification, wireless subscription plan specification, computer network connection speed specification, computer network connection type specification, display technology specification, display size specification, display resolution specification, software revision specification, connection coverage availability specification, connection technology specification, battery type specification, camera resolution quality specification, ability to customized specification, keyboard type specification, and GPS availability specification.

In an embodiment, an apparatus further comprises wherein the search results include a specification of a computing device.

In an embodiment, an apparatus further comprises wherein the search results include a pictorial depiction of the computer embedded object and a computer embedded object.

In an embodiment, an apparatus further comprises wherein the server charges an advertiser a fee for sending an advertisement to the user computer.

In an embodiment, an apparatus further comprises wherein the search results include a price of a computing device.

In an embodiment, an apparatus further comprises wherein a user initiates sending the search criteria from the user computer to the server.

In an embodiment, an apparatus further comprises a device, at a server, that receives a user's selection of one or more merchandise from the search results; a device, at a server, that adds the one or more selected merchandise to an electronic shopping checkout system.

In an embodiment, an apparatus further comprises wherein the one or more merchandise may be selected from the following group: a computing device and a mobile device accessory.

In an embodiment, an apparatus further comprises wherein the computing device may be a mobile device.

In an embodiment, an apparatus further comprises wherein the mobile device may be a cellular phone device or an ebook.

In an embodiment, an apparatus further comprises wherein the mobile device accessory may be selected from the following group of: a headset, case, pouch, or mobile device charger.

In an embodiment, an apparatus further comprises a device that includes, in the search results, a price and availability of merchandise in the search results; a device that accepts user input selection of a quantity of each of the merchandise for purchasing; a device that transfers the selected quantity of each of the selected merchandise to a computer network shopping basket; a device that accepts user input to purchase the selected quantity of each of the selected merchandise; a device that notifies the user of the completion of the purchase.

In an embodiment, an apparatus comprises subsystems, implemented at least partially in hardware for: wherein the identification code derived from the hostname of the computer embedded object and an identity authenticating password, and wherein the identity authenticating password and the hostname of the computer embedded object may be used for accessing the identification code stored in computer embedded object.

In an embodiment, an apparatus further comprises a device, at a server, stores at least partial of the search criteria in a database, wherein the partial stored search criteria including at least one hostname and one corresponding identification code of a computer embedded object.

In an embodiment, an apparatus further comprises wherein the at least one hostname and one corresponding identification code of a computer embedded object manually input by the user through a computer user interface.

In an embodiment, an apparatus further comprises wherein the at least one hostname and one identification code of a computer embedded object partially derived from a user purchasing history database.

In an embodiment, an apparatus further comprises a device, at a server, that receives at least one comment related to the computer embedded object from a user computer; a device, at a server, that stores the comment in a database.

In an embodiment, an apparatus further comprises a device, at a server, that receives at least one comment from a second user computer; a device, at a server, that stores the comment from the second user computer in a database.

In an embodiment, an apparatus further comprises a device, at a server, that receives an updated search criteria, wherein the updated search criteria derived from the search results.

In an embodiment, an apparatus further comprises wherein the search results includes specification of the merchandise of interest.

In an embodiment, an apparatus further comprises wherein the identification code derived from the hostname of the computer embedded object and an identity authenticating password, and wherein the identity authenticating password and the hostname of the computer embedded object may be used for accessing the identification code stored in computer embedded object.

In an embodiment, an apparatus further comprises a device, at a user computer, that stores at least partial of the search criteria in a database, wherein the partial stored search criteria including at least one hostname and one corresponding identification code of a computer embedded object.

In an embodiment, an apparatus further comprises wherein the at least one hostname and one corresponding identification code of a computer embedded object manually input by the user through a computer user interface.

In an embodiment, an apparatus further comprises wherein the at least one hostname and one identification code of a computer embedded object partially derived from a user purchasing history database.

In an embodiment, an apparatus further comprises a device, at a user computer, that receives at least one comment related to the computer embedded object from a user computer; a device, at a user computer, that stores the comment in a database.

In an embodiment, an apparatus further comprises wherein the user computer may be the first user computer and, further comprising: a device, at a second user computer, that receives at least one comment related to the computer embedded object from the second user computer; a device, at a second user computer, that stores comment from the second user computer in a database.

In an embodiment, an apparatus further comprises a device, at a user computer, that receives an updated search criteria, wherein the updated search criteria derived from the search results.

In an embodiment, an apparatus further comprises, wherein the search results includes specification of the merchandise of interest.

In an embodiment, an apparatus comprises subsystems, implemented at least partially in hardware for: a device, at a user computer, that, in response to receiving input from a user, retrieves a hostname of a computer embedded object; a device, at a user computer, that sends search criteria to a server, the search criteria including at least the identification code of a computer embedded object, wherein the identification code derived computer embedded objects; a device, at a user computer, that receives search results from the server, the search results including a description of merchandise of interest derived from the identification code of the computer embedded object; a device, at a user computer, that displays the search results to a user on a display communicatively connected to the user computer.

In an embodiment, an apparatus further comprises wherein the search results include a specification of a computing device.

In an embodiment, an apparatus further comprises wherein the search results include a comparison specification of one or more computing devices or one or more replacement objects.

In an embodiment, an apparatus further comprises wherein selection of the one or more computing devices or the one or more replacement objects in the comparison specification may be based on a percentage of improvement over the computer embedded object.

In an embodiment, an apparatus further comprises wherein selection of the one or more computing devices or the one or more replacement objects in the comparison specification may be based on a percentage of improvement over the computer embedded object.

In an embodiment, an apparatus further comprises wherein the search results include comparison advertisements for one or more computing devices or for one or more replacement objects.

In an embodiment, an apparatus further comprises wherein the search results include a pictorial depiction of the computer embedded object and a replacement object.

In an embodiment, an apparatus further comprises wherein the search results include a price of a computing device or a replacement object.

In an embodiment, an apparatus further comprises a device, at a user computer, that reports to the server, any advertisements in the search results that the user views or selects.

In an embodiment, an apparatus further comprises a device, at a user computer, that reports to the server, any links in the search results that the user views or selects.

In an embodiment, an apparatus comprises subsystems, implemented at least partially in hardware for: a device, at a user computer, that, in response to receiving input from a user at a user computer, sends search criteria to a server, the search criteria including search terms for objects that the user may be interested in; a device, at a user computer, that receives search results from the server, the search results including a description of merchandise of interest; a device, at a user computer, that retrieves an identification code of a computer embedded object, wherein the identification code derived from hostname of the computer embedded object; a device, at a user computer, that filters the search results using the identification code of the computer embedded object; a device, at a user computer, that displays the filtered search results to a user on a display communicatively connected to the user computer.

In an embodiment, an apparatus further comprises wherein the search results include a specification of a computing device.

In an embodiment, an apparatus further comprises wherein the search results include a comparison specification of one or more computing devices or one or more replacement objects.

In an embodiment, an apparatus further comprises wherein selection of the one or more computing devices or the one or more replacement objects in the comparison specification may be based on a percentage of improvement over the computer embedded object.

In an embodiment, an apparatus further comprises wherein the search results include comparison advertisements for one or more computing devices or for one or more replacement objects.

In an embodiment, an apparatus further comprises wherein selection of the one or more computing devices or the one or more replacement objects in the comparison advertisements may be based on a percentage of improvement over the computer embedded object.

In an embodiment, an apparatus further comprises wherein the search results include a pictorial depiction of the computer embedded object and a replacement object.

In an embodiment, an apparatus further comprises wherein the search results include a price of a computing device or a replacement object.

In an embodiment, an apparatus further comprises a device, at a user computer, that reports to the server, any advertisements in the search results that the user views or selects.

In an embodiment, an apparatus further comprises a device, at a user computer, that reports to the server, any links in the search results that the user views or selects.

In an embodiment, an apparatus further comprises wherein the identification code derived from the hostname of the computer embedded object and an identity authenticating password, and wherein the identity authenticating password and the hostname of the computer embedded object may be used for accessing the identification code stored in computer embedded object.

In an embodiment, an apparatus further comprises a device, at a user computer, that stores at least partial of the search criteria in a database, wherein the partial stored search criteria including at least one hostname and one corresponding identification code of a computer embedded object.

In an embodiment, an apparatus further comprises wherein the at least one hostname and one corresponding identification code of a computer embedded object manually input by the user through a computer user interface.

In an embodiment, an apparatus further comprises wherein the at least one hostname and one identification code of a computer embedded object partially derived from a user purchasing history database.

In an embodiment, an apparatus further comprises a device, at a user computer, that receives at least one comment related to the computer embedded object from the user computer; a device, at a user computer, that stores the comment in a database.

In an embodiment, an apparatus further comprises a device, at a second user computer, that receives at least one comment related to the computer embedded object from the second user computer; a device, at a second user computer, that stores the comment from the second user computer in a database.

In an embodiment, an apparatus further comprises a device, at a user computer, that receives an updated search criteria, wherein the updated search criteria derived from the search results.

In an embodiment, an apparatus further comprises wherein the search results includes specification of the merchandise of interest.

In an embodiment, an apparatus comprises subsystems, implemented at least partially in hardware for: a device, at a server, that receives information relating to a computer embedded object of a first user of the plurality of users; and a device, at a server, that sends the information of the computer embedded object to a second user for display.

In an embodiment, an apparatus further comprises wherein the information comprises an identification code.

In an embodiment, an apparatus further comprises wherein the identification code may be stored in the computer embedded object.

In an embodiment, an apparatus further comprises wherein the identification code stored in a memory of the computer embedded object.

In an embodiment, an apparatus further comprises a device, at a server, that associates the identification code with a specification of the computer embedded object.

In an embodiment, an apparatus further comprises wherein the information comprise the comment information relating to the computer embedded object of a first user of the plurality of users.

In an embodiment, an apparatus further comprises wherein the comment information comprises information about the usage experience of the first user.

In an embodiment, an apparatus further comprises wherein the comment information comprises a log file of the computer embedded object.

In an embodiment, an apparatus further comprises wherein the comment information may be a tweet.

In an embodiment, an apparatus further comprises wherein the comment information may be located in a fan page.

In an embodiment, an apparatus further comprises wherein the social networking service may be any of: Facebook, twitter, and Google plus.

In an embodiment, an apparatus further comprises wherein the identification code may be derived from a hostname of the computer embedded object and an identity authenticating password.

In an embodiment, an apparatus further comprises wherein the identification code may be delivered through a computer network.

In an embodiment, an apparatus comprises subsystems of sharing identification information between a plurality of users participating in a social networking service, implemented at least partially in hardware for: a device, at a server, that receives information of a group computer embedded objects from a group of users; a device, at a server, selects consumer information from a database according to the received information; a device, at a server, that sends the selected consumer information to the group of users for display.

In an embodiment, an apparatus further comprises wherein the received information comprises any of or any combination of a list of identification codes, specifications, and carrier service plans.

In an embodiment, an apparatus further comprises wherein the consumer information comprises any of or any combination of promotion and advertisement information.

In an embodiment, an apparatus further comprises wherein the consumer information comprises any of or any coupons, sales information and promotion materials.

In an embodiment, an apparatus further comprises wherein the specifications includes the communication data rates of each of the group of computer embedded objects; wherein the communication data rates are utilized such that each of the embedded objects receive appropriate consumer information.

In an embodiment, an apparatus further comprises wherein each of the group of computer embedded objects includes a device type associated therewith; wherein each of the embedded objects receive appropriate consumer information based upon the device type.

In an embodiment, an apparatus further comprises wherein the identification code may be derived from a hostname of the computer embedded object and an identity authenticating password.

In an embodiment, an apparatus further comprises wherein the selected consumer information may be any of the selection or indication of the webpage setup by the users.

In an embodiment, an apparatus comprises subsystems of collecting data of a plurality of users participating in a social networking service, implemented at least partially in hardware for: a device, at a server, that accesses the data; and a device, at a server, that builds a database accessed by the server; wherein the data may be provided to the server from at least one of the computer embedded objects to build the database and wherein the data including a identification code of the at least one of the computer embedded object.

In an embodiment, an apparatus further comprises wherein the identification code of the at least one of the computer embedded object stored in the memory of the computer embedded object.

In an embodiment, an apparatus further comprises a device, at a server, that utilizes data mining techniques on the built database.

In an embodiment, an apparatus further comprises a device, at a server, that utilizes data management techniques on the built database.

In an embodiment, an apparatus further comprises wherein each of the computer embedded object include an identification code.

In an embodiment, an apparatus further comprises wherein the identification code may be stored in a memory of its associated computer embedded object embedded object.

In an embodiment, an apparatus further comprises a device, at a server, that associates the identification code with a specification of its computer embedded object.

In an embodiment, an apparatus further comprises wherein each of the specifications includes the data rates of each of the group of computer embedded objects; and wherein the data rates are utilized such that each of the embedded objects receive appropriate consumer information.

In an embodiment, an apparatus further comprises wherein each of the computer embedded objects includes a device type associated therewith; wherein each of the embedded objects receive appropriate consumer information based upon the device type.

In an embodiment, an apparatus further comprises wherein information between the computer embedded object and statistics of the computer embedded object are correlated with the usage of the computer embedded object.

In an embodiment, an apparatus further comprises wherein the information of the computer embedded object may be the model number of a portable device and the statistics are the viewing statistics of a text message of users that have the model number of the portable device, wherein the viewing statistics and the model number are correlated length of time the users are using the portable device.

In an embodiment, an apparatus further comprises wherein information between the computer embedded object and at least one parameter of the database are correlated to provide information to the provider.

In an embodiment, an apparatus comprises subsystems, implemented at least partially in hardware for: a device, at a server, that receives a merchandise of interest and a first list comprising an identification code of a computer embedded object from a computing device; a device, at a server, that combines a second list comprising at least one identification code of a computer embedded object with at least a portion of the first list to create a third list; a device, at a server, that processes an identification code from the third list to obtain a description from a database that matches the identification code; a device, at a server, that sends information to the computing device wherein the sent information is related to the merchandise of interest, the sent information derived from the description obtained from the database.

In an embodiment, an apparatus comprises subsystems, implemented at least partially in hardware for: a device, at a user computer, in response to receiving input from a user, retrieves a first list comprising an identification code of a computer embedded object; a device, at a user computer, that combines a second list comprising at least one identification code of a computer embedded object with at least a portion of the first list to create a third list; a device, at a user computer, that sends to a server a merchandise of interest and the third list; a device, at a user computer, that receives information related to the merchandise of interests from the server, wherein the received information derived from the third list.

### 10. Equivalents, Extensions, Alternatives and Miscellaneous

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer implemented method of sharing identification information between a plurality of users participating in a social networking service, each of the plurality of users having a computer embedded object, the method executed by a computer system, the method comprising:
receiving information relating to a computer embedded object of a first user of the plurality of users; and
sending the information of the computer embedded object to a second user for display.

2. The method of claim 1, wherein the information comprises an identification code.

3. The method of claim 2, wherein the identification code may be stored in the computer embedded object.

4. The method of claim 2, wherein the identification code stored in a memory of the computer embedded object.

5. The method of claim 2 further comprising:
associating the identification code with a specification of the computer embedded object.

6. The method of claim 2, wherein the information comprise the comment information relating to the computer embedded object of a first user of the plurality of users.

7. The method of claim 6, wherein the comment information comprises information about the usage experience of the first user.

8. The method of claim 6, wherein the comment information comprises a log file of the computer embedded object.

9. The method of claim 6, wherein the comment information may be a tweet.

10. The method of claim 16, where the comment information may be located in a fan page.

11. The method of claim 1, wherein the social networking service may be any of: Facebook, twitter, and Google plus.

12. The method of claim 2, wherein the identification code may be derived from a hostname of the computer embedded object and an identity authenticating password.

13. The method of claim 2, wherein the identification code may be delivered through a computer network.

14. A method of sharing identification information between a plurality of users participating in a social networking service, each of the plurality of users having a computer embedded object, the method executed by a computer system, the method comprising:
receiving information of group computer embedded objects from a group of users;
selecting consumer information according to the received information;
sending the selected consumer information to the group of users for display.

15. The method of claim 14, wherein the received information comprises any of or any combination of a list of identification codes, specifications, and carrier service plans.

16. The method of claim 15, wherein the consumer information comprises any of or any combination of promotion and advertisement information.

17. The method of claim 16, wherein the consumer information comprises any of or any coupons, sales information and promotion materials.

18. The method of claim 17, wherein the specifications includes the communication data rates of each of the group of computer embedded objects; wherein the communication data rates are utilized such that each of the embedded objects receive appropriate consumer information.

19. The method of claim 17, wherein each of the group of computer embedded objects includes a device type associated therewith; wherein each of the embedded objects receive appropriate consumer information based upon the device type.

20. The method of claim 14, wherein the identification code may be derived from a hostname of the computer embedded object and an identity authenticating password.

21. A method for collecting data of a plurality of users participating in a social networking service, each of the plurality of users having a computer embedded object connected to a computer network, the method executed by a computer system, the method comprising:
providing a server to access the data; and
building a database accessed by the server; wherein the data may be provided to the server from at least one of the computer embedded objects to build the database and wherein the data including a identification code of the at least one of the computer embedded object.

22. The method of claim 21 wherein the identification code of the at least one of the computer embedded object stored in the memory of the computer embedded object.

23. The method of claim 21 further comprising utilizing data mining techniques on the built database.

24. The method of claim 21 further comprising utilizing data management systems on the built database.

25. The method of claim 21, wherein each of the computer embedded object include an identification code.

26. The method of claim 25, wherein the identification code may be stored in a memory of its associated computer embedded object embedded object.

27. The method of claim 25 further comprising:
associating the identification code with a specification of its computer embedded object.

28. The method of claim 27, wherein each of the specifications includes the data rates of each of the group of computer embedded objects; wherein the data rates are utilized such that each of the embedded objects receive appropriate consumer information.

29. The method of claim 27, wherein each of the computer embedded objects includes a device type associated therewith; wherein each of the embedded objects receive appropriate consumer information based upon the device type.

30. The method of claim 27, wherein information between the computer embedded object and statistics of the computer embedded object are correlated with the usage of the computer embedded object.

31. The method of claim 30, wherein the information of the computer embedded object may be the model number of a portable device and the statistics are the viewing statistics of a text message of users that have the model number of the portable device, wherein the viewing statistics and the model number are correlated length of time the users are using the portable device.

32. The method of claim 30, wherein information between the computer embedded object and at least one parameter of the database are correlated to provide information to the provider.

33. A method comprising:
receiving, at a server, a merchandise of interest and a first list comprising an identification code of a computer embedded object from a computing device;
combining, by the server, a second list comprising at least one identification code of a computer embedded object with at least a portion of the first list to create a third list;
processing, by the server, an identification code from the third list to obtain a description from a database that matches the identification code;
sending information, from the server, to the computing device wherein the sent information is related to the merchandise of interest, the sent information derived from the description obtained from the database.

34. A method comprising:
in response to receiving input from a user at a user computer, retrieving a first list comprising an identification code of a computer embedded object;
combining, by the user computer, a second list comprising at least one identification code of a computer embedded object with at least a portion of the first list to create a third list;
sending, by the user computer, to a server a merchandise of interest and the third list;
receiving, by the user computer, information related to the merchandise of interests from the server, wherein the received information derived from the third list.
